(19) United States
(12) Patent Application Publication
(10) Pub. No.: US 2025/0269663 A1
(43) Pub. Date: Aug. 28, 2025

(54) Inline Printer for Printing Discrete Three-Dimensional Articles Of Varying Size

(71) Applicant: Food Printing Technologies, LLC, Williamsville, NY (US)

(72) Inventors: Theodore F. Cyman, JR., Minneola, FL (US); Philip T. Hart, Williamsville, NY (US); David M. Cyman, Minneola, FL (US); Robert J. Russell, Tonawanda, NY (US)

(21) Appl. No.: 19/059,944

(22) Filed: Feb. 21, 2025

Related U.S. Application Data
(60) Provisional application No. 63/557,213, filed on Feb. 23, 2024.

(51) Int. Cl. B41J 3/407; A23P 20/15; A23P 20/25; B41J 2/21; B41J 3/46; B41J 3/62; B41J 11/00; B41J 13/08; B41J 25/304; B41M 5/00; G06K 15/02

(52) U.S. Cl. CPC B41J 3/4073; A23P 20/15; B41J 2/2103; B41J 3/46; B41J 3/62; B41J 11/0095; B41J 13/08; B41J 25/304; B41M 5/0088; G06K 15/021; G06K 15/1843; A23P 2020/253; G06K 2215/101

(57) ABSTRACT

A printing apparatus for printing three-dimensional edible articles includes a conveyor, an ink supply station, and a height-adjustable inkjet print head module to deposit edible inks as full-color images onto the articles. A computer vision station upstream of the print head module scans and identifies the physical parameters of each article. The ascertained parameters may include the height, width and length of the article, and its orientation and position on the conveyor. A data store retains at least one digital image to be printed. A control system is operable to perform image transformation of the digital image in order to transform it into a transformed image that is compatible with each article scanned by the computer vision station. The image transformation utilizes the physical parameters gathered by the computer vision station and involves a transformation process to adjust the image size, orientation, and position to match the scanned article.

### CROSS-REFERENCE TO RELATED APPLICATIONS

This is a U.S. patent application claiming priority to and the benefit under 35 U.S.C. 119(e) of U.S. Provisional Application Ser. No. 63/557,213, filed Feb. 23, 2024. The contents of said provisional application are incorporated herein by this reference in their entirety.

### BACKGROUND

### Field

The present disclosure pertains to the field of non-contact in-line printing systems, more specifically to a method and apparatus for printing images directly onto three-dimensional food items using advanced inkjet printing and computer vision techniques for precise, adaptable imagery on edible articles.

### Description of the Prior Art

The technological landscape prior to the advent of the current invention lacks a multifaceted understanding of advancements and challenges within 3D printing technology, inline production processes, and non-contact printing methodologies, especially contextualized within the food industry. This Background discussion delineates the evolution and the specific pain points that have necessitated the innovation of the Inline Printer for Printing Discrete Three-Dimensional Articles Of Varying Size, as disclosed herein.

Historically, the task of printing onto three-dimensional articles, particularly within the ambit of food production, has been fraught with challenges. Traditional printing methods either necessitated direct physical contact between the printing apparatus and the edible items or relied on manually applying pre-printed edible transfers onto the surface of these items. While these approaches were adequate for specific applications, they were marred by significant limitations. The propensity for direct contact methods to damage the delicate surfaces of food items, coupled with a lack of flexibility to accommodate a diversity in item sizes and shapes within a high-volume production environment, underscored the inefficiencies—resulting in escalated production times and costs.

The introduction of inkjet printing technology brought forth a considerable advancement by facilitating direct printing onto items sans physical contact. However, the application of this technology to inline printing on a variety of food products introduces complex challenges. These include accommodating the varied geometries and sizes of food items, ensuring the adherence and edibility of inks, and achieving high-quality, accurate prints on irregularly shaped surfaces—all imperative for maintaining graphic quality and legibility.

Furthermore, despite the onset of computer vision systems being deployed within manufacturing lines for defect inspection, their application and optimization within inline food printing systems has, as far as known, not been achieved. There is thus an unmet need in the efficient mapping of images onto food items of varying dimensions at the speed required by rapid production schedules. Additionally, issues related to the precision of ink delivery on items with inconsistent shapes and surfaces highlight the limitations of conventional inkjet printing heads, which are unable to dynamically adjust to the article's geometry, leading to degraded image quality.

In light of the technological advancements and heightened automation within the manufacturing sector, applicant has recognized the emergence of a clear potential for integrating more sophisticated control systems into printing operations. Applicant envisions that such systems, if properly adapted, hold the promise of automated adjustments for print head positioning, ink flow, and image transformation dynamically in real time, offering a solution to the challenges outlined above.

What is needed is a printing system that addresses these challenges by leveraging the latest advancements in computer vision, inkjet technology, and dynamic control systems. The Inline Printer for Printing Discrete Three-Dimensional Articles Of Varying Size as disclosed herein meets this need by offering an innovative, efficient solution for inline, non-contact printing. The invention's ability to dynamically transform images based on real-time dimensions of each food item represents a pivotal enhancement. This innovation is designed to significantly improve the flexibility, speed, and quality of food printing processes within a production line environment, overturning the limitations of previous methodologies and setting a new standard in the field.

### SUMMARY

An apparatus for in-line, non-contact printing on three-dimensional edible articles. The apparatus includes a conveyor operable to move three-dimensional edible articles, an ink supply station operable to maintain a supply of edible inks of different colors, and a height-adjustable inkjet print head module in communication with the ink supply station to deposit the edible inks as full-color images onto the articles while they are being conveyed on the conveyor. A computer vision station is situated upstream of the print head module to scan and identify the physical parameters of each article passing by the computer vision station on its way to the print head module for printing. The ascertained parameters may include the height, width and length of the article, and its orientation and position on the conveyor. A data store is provided for retaining at least one digital image to be printed on the articles. A control system is operable to perform image transformation of the digital image in order to transform it into a transformed image that is compatible with each article scanned by the computer vision station. The image transformation utilizes the physical parameters gathered by the computer vision station and involves a transformation process to adjust the image size, orientation, and position to match the scanned article.

### BRIEF DESCRIPTION OF THE DRAWINGS

FIG. 1 shows a front elevation view of an apparatus for in-line, non-contact printing of images onto three-dimensional edible articles, illustrating components such as a conveyor, a laser vision station, an ink supply station, an adjustable inkjet print head module, a computer vision station, a control system, and an operator control panel.

FIG. 2 is a plan view of the printing apparatus of FIG. 1.

FIG. 3 is a right side elevation view of the printing apparatus of FIG. 1.

FIG. 4 is a left side elevation view of the printing apparatus of FIG. 1.

FIG. 5 is a front elevation view of the printing apparatus of FIG. 1, showcasing a Learn Procedure of the apparatus.

FIG. 6 is a plan view the printing apparatus of FIG. 1, showcasing the Learn Procedure.

FIG. 7 is a left side elevation view of the printing apparatus of FIG. 1, showcasing the Learn Procedure.

FIG. 8 is a front elevation view of the printing apparatus of FIG. 1, showcasing a Printing Procedure.

FIG. 9 is a plan view of the printing apparatus of FIG. 1, showcasing the Printing Procedure.

FIG. 10 is a schematic view of the printing apparatus of FIG. 1, depicting a computer vision scanner, a control system, and an adjustable inkjet print head module positioned above a product conveyor, where the print head module includes two print head pairs and a height adjuster located between the heads for in-line, non-contact printing onto three-dimensional edible articles.

FIG. 11 is a block diagram of a control system of the printing apparatus of FIG. 1, illustrating an operational workflow for article measurements, image processing, transformation, and transfer to the print head module.

FIG. 12 is a screenshot of an operator control panel for the printing apparatus of FIG. 1, showing a dashboard interface with a printing control region, an image management region, and print head motion state region.

FIG. 13 is a screenshot of the dashboard interface of FIG. 12, showing the print control region thereof.

FIG. 14A is a screenshot of the dashboard interface of FIG. 12, showing an Adjustments sub-menu of the print control region.

FIG. 14B is a screenshot of the dashboard interface of FIG. 12, showing a Color sub-menu of the print control region.

FIG. 15 is a screenshot of the dashboard interface of FIG. 12, showing an image management region thereof.

FIG. 16 shows a series of screenshots of the dashboard interface of FIG. 12, depicting print head motion states in the print head motion state region of the interface and an image size adjustment sub-menu in a print control region of the interface, showcasing a Start Up & Printing Procedure that may be implemented by the apparatus of FIG. 1.

FIG. 17 shows screenshots of the print control region of the dashboard interface of FIG. 12 and a depiction of a power control panel of the printing apparatus of FIG. 1, showcasing a Printing Procedure that may be implemented by the printing apparatus.

FIG. 18 shows a screenshot of the print control region of the dashboard interface of FIG. 12, and a depiction of the conveyor of the printing apparatus of FIG. 1, showcasing a Learn Procedure that may be implemented by the printing apparatus.

FIG. 19 is a screenshot of the dashboard interface of FIG. 12, with the print control region thereof exposing various test print options.

FIG. 20 is a screenshot of an operator control panel for the printing apparatus of FIG. 1, showing an advanced print control interface with a status region, an image management region, and a settings region in which a print image size control sub-menu is exposed for use.

FIG. 21 is a screenshot of the advanced print control interface of FIG. 20, with a system configuration menu being exposed for use in the settings region.

FIG. 22 is a screenshot of the advanced print control interface of FIG. 20, with an image adjustments sub-menu being exposed for use in the settings region.

FIG. 23 is a screenshot of the advanced print control interface of FIG. 20, with an advanced sub-menu being exposed for use in the settings region.

FIG. 24 is a screenshot of the advanced print control interface of FIG. 20, with a test print status region mode sub-menu being open for use to allow testing of various image patterns.

FIG. 25 is a screenshot of an operator control panel for the printing apparatus of FIG. 1, showing an Ink supply interface with an actions region and a levels region.

FIG. 26 is a screenshot of an operator control panel for the printing apparatus of FIG. 1, showing an advanced settings interface with a support files region and a preferences region in which a devices sub-menu is exposed for use.

FIG. 27 is a screenshot of the advanced settings interface of FIG. 26, with a camera sub-menu exposed for use in the preferences section.

FIG. 28 is a screenshot of the advanced settings interface of FIG. 26, with an ink sub-menu exposed for use in the preferences region.

FIG. 29 is a screenshot of the advanced settings interface of FIG. 26, with a print sub-menu exposed in the preferences region.

FIG. 30 is a screenshot of the advanced settings interface of FIG. 26, with a print module sub-menu being exposed for use in the preferences region.

FIG. 31 is a screenshot of the advanced settings interface of FIG. 26, with a cleaning module sub-menu exposed for use in the preferences region.

FIG. 32 is a screenshot of the dashboard interface of FIG. 12, with the print head motion status region displaying an indication that print heads are in motion.

FIG. 33 is a screenshot of the dashboard interface of FIG. 12, with the print head motion status region displaying an indication that prints heads are in a set position.

FIG. 34 is a screenshot of the dashboard interface of FIG. 12, with an ink status region thereof indicating an ink supply station status.

FIG. 35 is a screenshot of the dashboard interface of FIG. 12, with an ink status region thereof indicating another ink supply station status.

FIG. 36 is a screenshot of an alternate ink supply interface that is redundant to the ink supply interface of FIG. 25, wherein the alternate ink supply interface is generated by an ink supply station control system.

FIG. 37 is a screenshot of an operator control panel for the printing apparatus of FIG. 1, showing a global settings interface with a parameters region and a COM region.

FIG. 38 is a diagrammatic plan view of the printing apparatus of FIG. 1, having a conveyor with a single article scanning and printing lane for printing one article at a time.

FIG. 39 is a diagrammatic plan view of another printing apparatus having a conveyor with two article scanning and printing lanes for printing two articles in parallel.

FIG. 40 is a diagrammatic plan view of another printing apparatus having a conveyor with three article scanning and printing lanes for printing three articles in parallel.

FIG. 41 is a diagrammatic plan view of another printing apparatus showing a stack of three conveyors of the printing apparatus of FIG. 40 arranged for printing nine articles in parallel.

FIG. 42 is a diagrammatic plan view of another printing apparatus wherein there are three groups of the three-conveyor printing apparatus of FIG. 40 arranged for printing twenty-seven articles in parallel.

FIG. 43 is a diagrammatic plan view of another printing apparatus designed for a small scale article printing production environment, the apparatus including a computer vision station having multiple low cost laser proximity scanners respectively arranged to function as a start scanner, a left angle scanner, a right angle scanner, an end scanner, a height scanner, and height-to-high scanner.

FIG. 44 is a diagrammatic side view of the printing apparatus of FIG. 43, illustrating operation the height scanner and the height-to-high scanner of the computer vision station.

FIG. 45 is a functional block diagram illustrating control components for obtaining article measurements using the computer vision station of the printing apparatus of FIG. 43.

### DETAILED DESCRIPTION

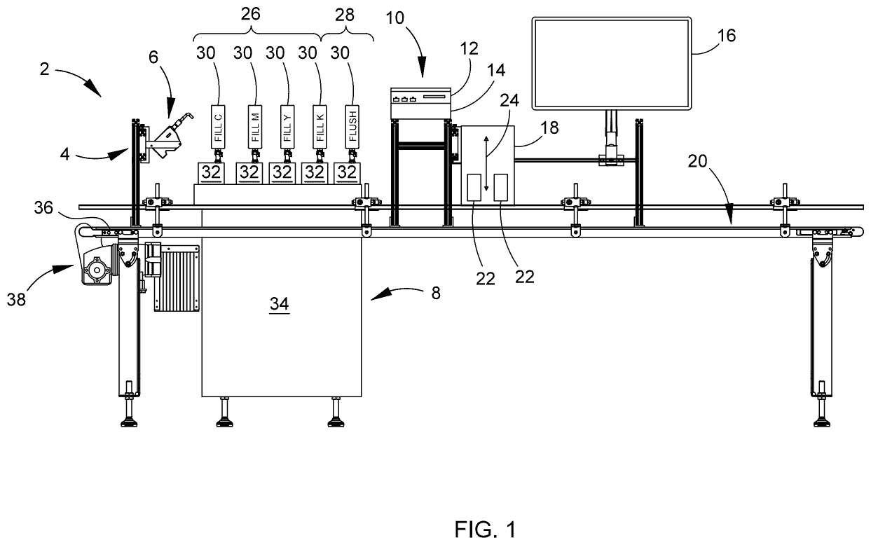

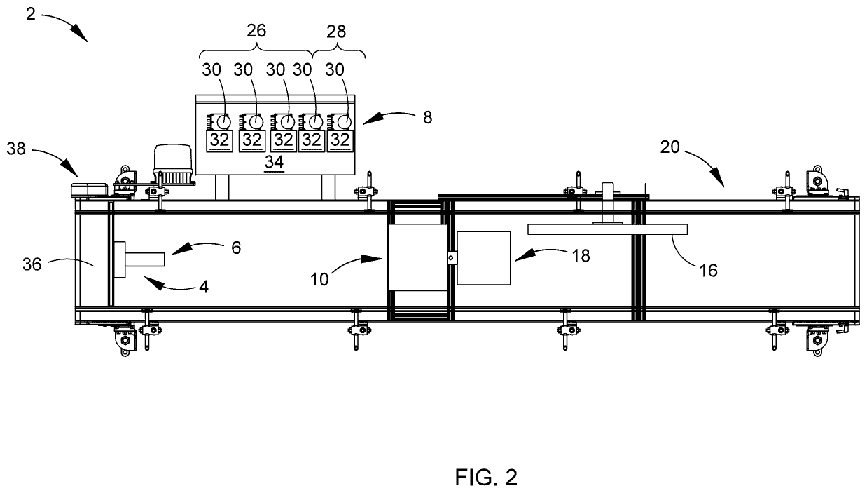

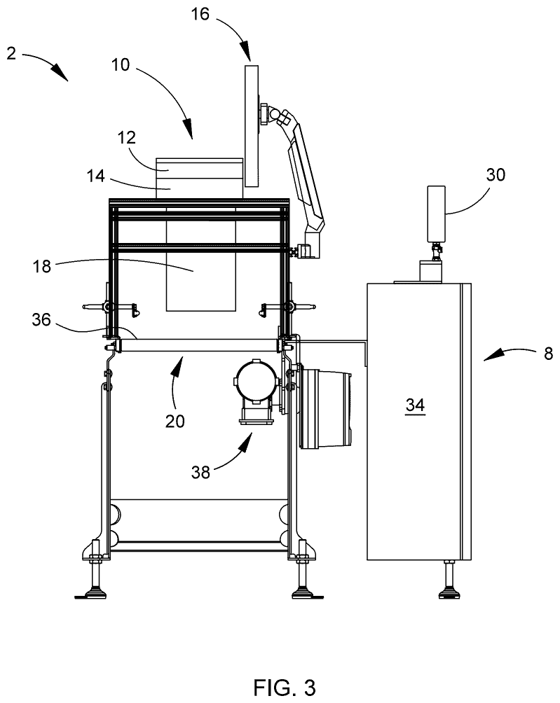

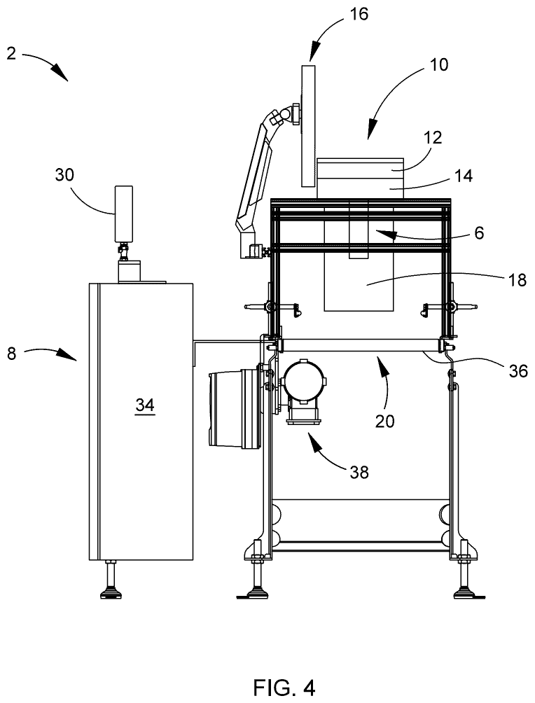

Turning now to the drawings, FIGS. 1-4 illustrate an inline printing apparatus 2 according to one possible implementation of the invention. FIGS. 1-4 respectively shows a side elevation view, a plan view, a right side (tail end) view and a left side (head end) view of the printing apparatus 2.

Representative components of the printing apparatus 2 shown in FIGS. 1-4 include an article profiling station 4 with a three-dimensional (3D) article profile scanner 6 that may be implemented using a 3D laser vision profiler (or other optical profiler), an ink supply station 8, a control System 10 that includes drive electronics 12 and a print head motion control system 14, an operator control panel 16, an adjustable inkjet print head module 18, and a conveyor 20.

The laser vision profiler used to implement the article profile scanner 6 may be provided by a laser vision profiling system capable of making accurate 3D measurements of moving targets. By way of example only, the LJ-X8400 Laser Profiler from Keyence Corporation of America, Itasca, IL, is one such system. The LJ-X8400profiler utilizes a laser displacement transmitter/sensor that emits a laser line from the transmitter onto a target and collects reflected measurement data at the sensor (which is offset from the transmitter and angled relative thereto). This enables 3D measurements such as height, width, length, orientation and x-y position to be performed using a single profiler device. The LJ-X8400 features a Blue semiconductor laser operating at a wavelength of 405 nm. It has a Z-axis measurement range of +/−60 mm at a reference distance of 380 mm, and an X-axis (width) measurement range of 180 mm (near side) and 240 mm (far side) at a reference distance of 210 mm. The LJ-X8400 is capable of acquiring profile data at intervals of 75 um along the X-axis, and can provide a 3200 point measurement data count.

The ink jet print head module 18 may be implemented in one example configuration with two pairs of ink jet print heads 22 situated next to each other in the conveyor motion direction (Y-axis), with each pair of the print heads being mounted to a movable print head carrier 24 for up and down (Z-axis) height adjustment as a print head group. By way of example only, a first pair of the ink jet print heads 22 may print cyan (C) and magenta (M) color images while a second pair of the ink print heads 22 may print yellow (Y) and black (K) color images.

As described in more detail below, the print head module 18 may be placed in various positions depending on the operational mode of the printing apparatus 2. These positions include a Home position, a Park position, a Clean position, a Hand Wipe position and a Print position. Although not shown, a cleaning tray may be provided for protectively sealing the print heads 22 between print jobs, and collecting ink during a print head flushing operation.

The ink supply station 8 may be implemented as a modular system having four separate ink modules 26 for the cyan (C), magenta (M), yellow (Y) and black (K) color inks, and a (fifth) flush module 28 for a flushing fluid used for cleaning the ink pathways. Each ink module 26 (and the flush module 28) includes an upper fill vessel 30 where ink (or flush fluid) is added, and a lower supply vessel 32 connected via a gravity-feed arrangement (not shown) to a print head 22. Optical sensors (not shown) may be used to detect the ink (or fluid) level in the supply vessels 32, so that ink (or fluid) may be added or removed therein in order to maintain a suitable pressure head.

In an alternate embodiment of the printing apparatus 2, the ink supply station 8 may further include ink modules 26 for printing specialty inks, such as highly accurate spot colors created using a specific premixed ink recipe, or white inks that can be used to print backgrounds prior to printing other colors, etc. An ink module 26 could also be provided as part of the ink supply station 8 for printing coatings that improve the quality of edible ink images printed on certain food products (such as chocolate). This provides an advantage over techniques that rely on spray-coating an entire article because a printed coating can be controllably applied in at any desired location on the article with any desired coating shape or pattern.

The control System 10 may be implemented as programmed computer having a processor, a memory, a data storage, input/output functionality, and which is suitably programmed with software and/or firmware to perform the required processing needed to control the operations of the printing apparatus 2. In FIGS. 1-4, the control System 10 is shown to include the drive electronics 12 for driving the print operation and the print head motion control system 14 for adjusting the position of the print head carrier 24 that forms part of the print head module 18.

The operator control panel 16 may be implemented in an example configuration as a touch screen that supports both input and output operations for the control System 10. Alternatively, a standard computer monitor could be provided for information output and a standard keyboard and mouse combination could be provided for information input.

An ink supply control system 34 may also be provided as part of the ink supply station 8. The ink supply control system 34 may be connected to the operator control panel 16 to allow an operator to monitor and adjust ink supply parameters independently of the main control System 10.

The conveyor 20 may be implemented using any food-grade conveyor belt system of sufficient width (X-axis direction) and length (Y-axis direction) to accommodate the production capacity required of the printing apparatus 2. The conveyor 20 may include a conveyor belt 36 powered by a conveyor belt drive system 38 capable of driving the conveyor belt at a linear speed of 10-200 feet/minute or more.

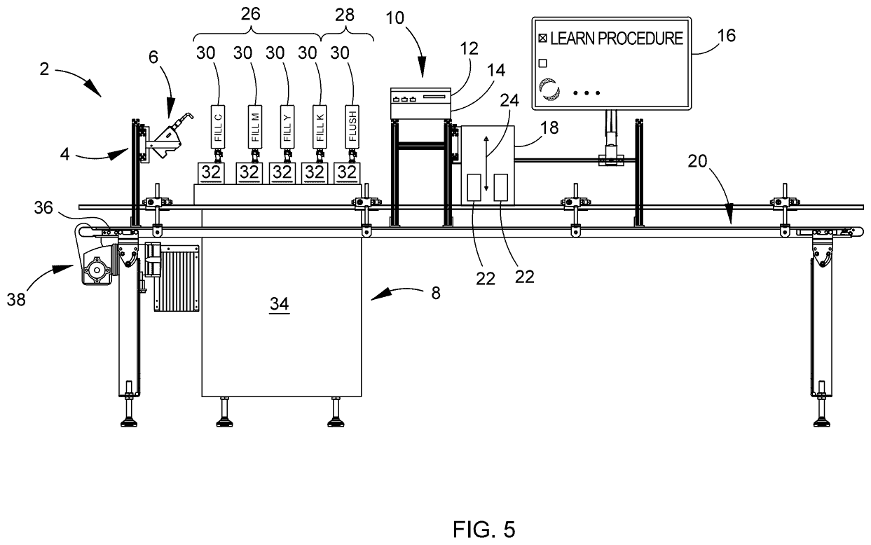

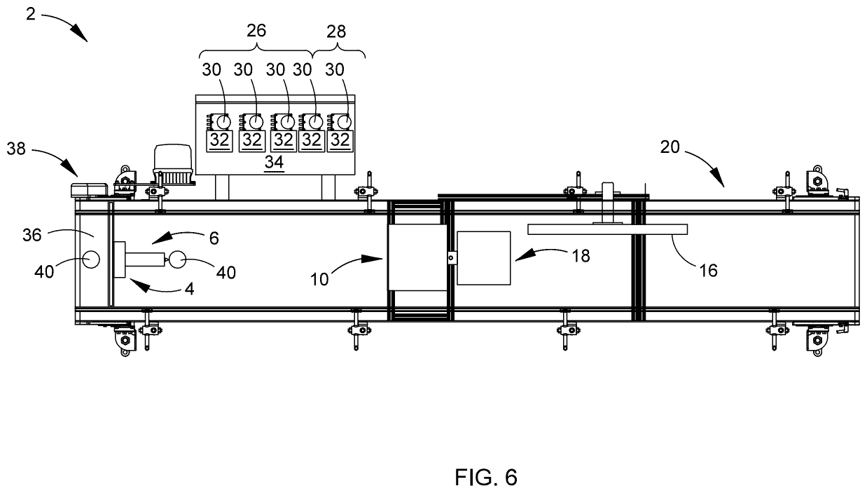

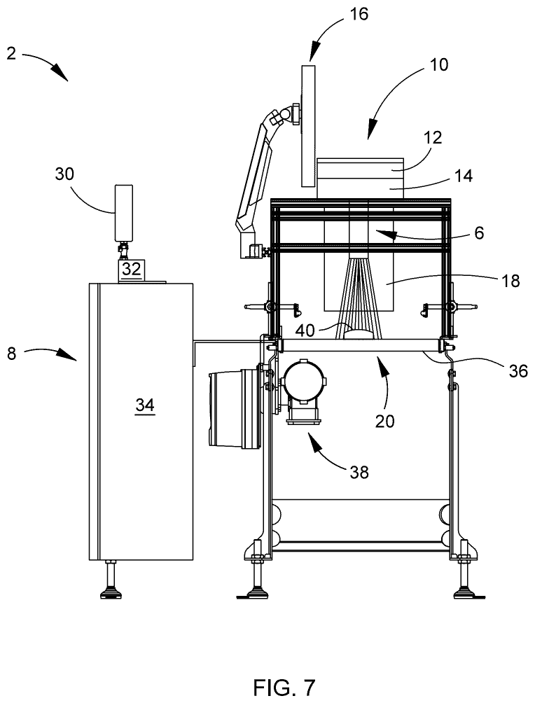

FIGS. 5-7 depict the printing apparatus 2 implementing an optional Learn Procedure 42 that may be used when setting up a new print production run (e.g., on a new article 40). As shown in FIG. 5, the Learn Procedure 42 is implemented by a production operator interacting with the operator control panel 16 by selecting the illustrated Learn Procedure option. The operator uses the operator control panel 16 to select one or more digital images (e.g., PNG files) to be printed. The operator places a single article 40 on the conveyor 20 upstream of the article profiling station 4 and uses the operator control panel 16 to invoke the Learn Procedure 42 option, thereby activating the conveyor belt 36 and moving the single article 40 past the article profile scanner 6 as it takes 3D measurements of the article. The article profile scanner 6 uploads the 3D measurement information to the control System 10 and the control system uses the 3D measurement information to perform transformations on the digital image(s) so that the image(s) will properly fit and align within the perimeter of the article 40, usually with some amount of buffer spacing between the edge of each image and the edge of the article. Such transformations may include scaling and rotation of the digital image(s) according to the measured width, length and orientation of the article 40.

The control System 10 also adjusts the print head height according to the measured height of the article 40 in order to place the print heads 20 at an appropriate spacing distance from the article. In an embodiment, a print head spacing distance of 0.100-0.125 inches may be used.

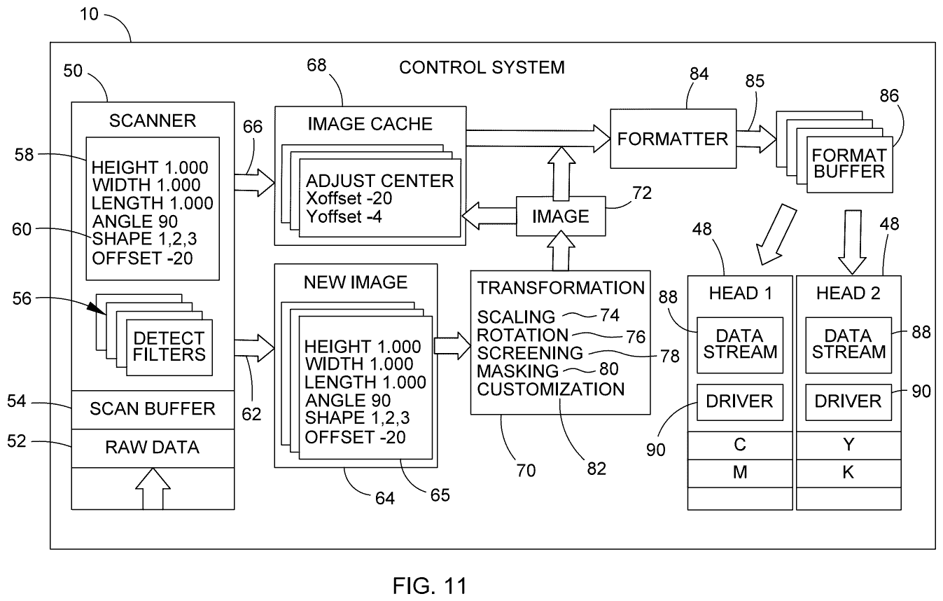

At this stage, the control System 10 may perform additional transformations on the digital image(s), such as screening, masking and additional customizations to produce a CMYK halftone raster image. These transformation operations are described in more detail hereinafter in connection with FIG. 11.

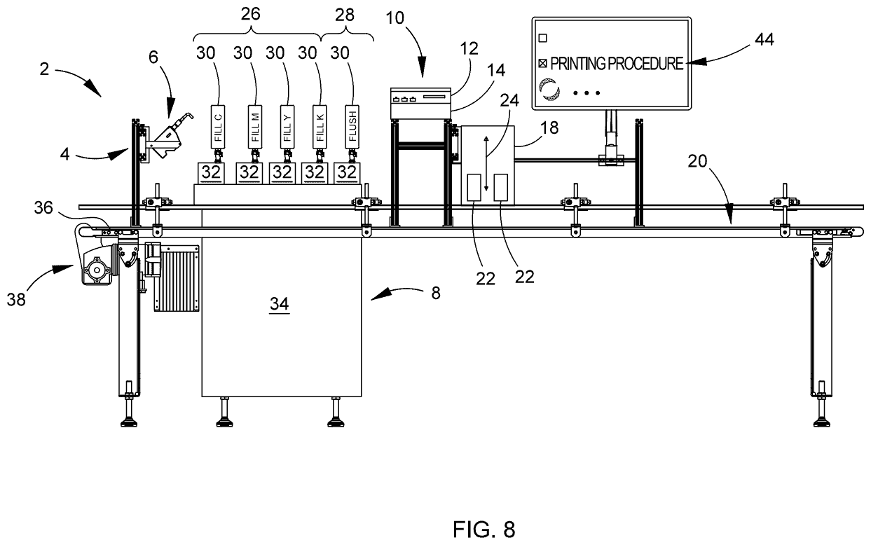

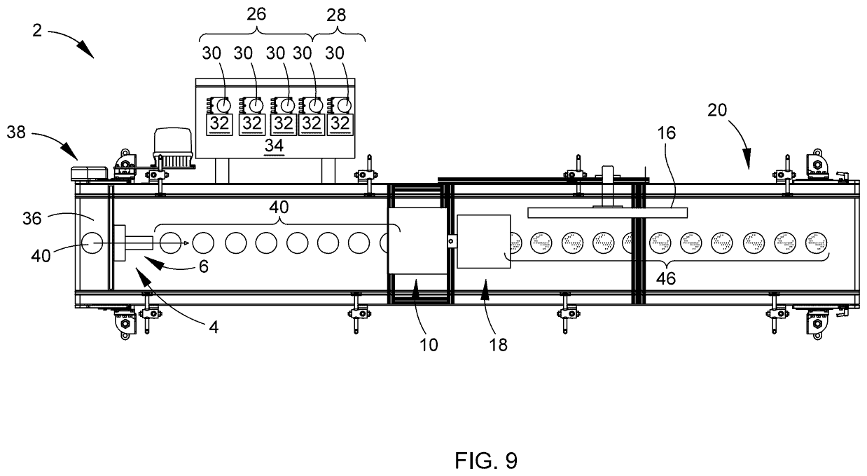

FIGS. 8-9 depict the printing apparatus 2 implementing a Printing Procedure 44. As shown in FIG. 8, the Printing Procedure 44 is implemented by an operator interacting with the operator control panel 16 by selecting the illustrated Printing Procedure option. The conveyor 20 is started and the operator (or an automated system) begins placing articles 40 on the moving conveyor belt 36. If desired, side rails or other guides (physical or visual) may be used at the article placement location to fix or establish the lateral (X-axis) position of the articles 40. The article profiling station 4 operates its article profile scanner 6 to detect each article 40 as it passes by, and reports article scanning data to the control System 10. The control System 10 receives the article scanning data and activates the print heads 22 at the appropriate time to lay down their respective CMYK ink patterns. Following printing, the previously unprinted articles 40 become printed articles 46, as shown in FIG. 9. If there are multiple images to be printed on different articles 40, the control system 20 may print each image in sequence on a corresponding sequence of the articles.

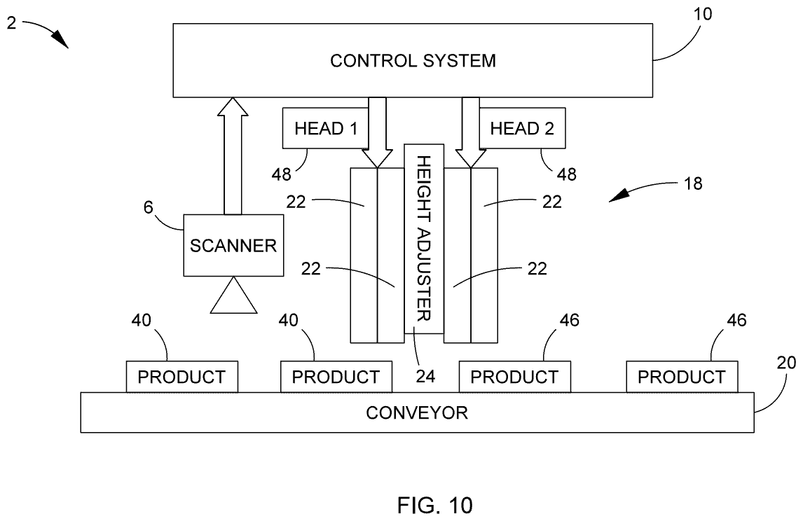

Turning now to FIG. 10, the printing apparatus 2 of FIGS. 1-9 is shown in diagrammatic form, with the apparatus implementing the Printing Procedure 44. FIG. 10 illustrates the conveyor 20 as it carries a series of articles 40 (denominated as “Products”) to be printed, with the articles first passing under the article profile scanner 6 (denominated as “Scanner”) and then under the print head module 18. The print head module 18 includes the previously-described pairs of ink jet print heads 22 (denominated as head pairs 48 labeled “Head 1” and “Head 2”) and the print head carrier 24 (denominated as a “Height Adjuster”). The first head pair 48 (Head 1) may include the cyan and magenta ink jet print heads 22. The second head pair 48 (Head 2) may include the yellow and black ink jet print heads 22. As previously mentioned, the article profile scanner 6 scans each article 40 and uploads its measurement data to the control System 10. The control System 10 uses this information to generate the CMYK images that respectively drive each ink jet print head 22 to produce the printed articles 46 (also denominated as “Products”).

Turning now to FIG. 11, the control System 10 of the printing apparatus 2 is shown using a combined flow and functional block diagram format. The functional block labeled “Scanner 50” on the left side of FIG. 11 processes Raw Data 52 representing the measurement information arriving from the article profiling station 4. The Raw Data 52 is buffered in a Scan Buffer 54 for processing by one or more Detect Filters 56 that select and extract the appropriate measurements 58 needed by the printing apparatus 2 to print onto an article 40. These measurements 58 may include a Height (Z-axis) maximum, a Width (X-axis) maximum, a Length (Y-axis) maximum, an Angle of rotation (orientation), and an X-axis Offset value (from the center of the article profile scanner 6 to the center of the article 40), as determined according to a Shape parameter 60 assigned to the article. The Shape parameter 60 specifies the geometric shape of a virtual containment object within which the article 40 being measured will fit. The Shape parameter 60 determines which of the Detect Filters 56 will be used. By way of example, a Shape parameter 60 that specifies the selection of a virtual containment object of rectangular prismatic shape will give rise to the Scanner 50 acquiring the Height, Width, Length, Angle and Offset measurements from the Raw Data. Other shapes (e.g., circular, triangular, hexagonal, etc.) may also be used to establish the Shape parameter 60.

There are two processing pathways emanating from the Scanner 50 in FIG. 11. A lower pathway 62 leads to a New Image store 64 and an upper pathway 66 leads to an Image Cache 68. The lower pathway 62 represents slow path processing that takes place during either an Initial Learn Procedure 42 or during a Printing Procedure 44 that is not preceded by the Learn Procedure. The upper pathway 66 represents fast path processing that takes place during a Printing Procedure 44 that is preceded by the Learn Procedure 42.

### Slow Path Processing

The lower pathway 62 results in a previously unprocessed New Image 65 (such as PNG file or other electronic display format image) being processed by a Transformation Unit 70 using the measurement data provided by the Scanner 50 for a particular article 40. The New Image store 64 shows the measurement data produced by the Scanner's Detect Filters 56 for each New Image 65, as discussed previously.

The Transformation Unit 70 performs various operations on an as needed basis, with the output result being a Transformed Image 72 (“Image”) properly sized, oriented and positioned for the scanned article 40, and formatted as a CMYK raster image suitable for ink jet printing. The Transformed Image 72 is composed of single-color raster (bitmap) image data for each of the print colors cyan, magenta, yellow and black. The Transformed Image 72 includes the data needed for each pixel to be printed in a particular CMYK color in order to form the halftone dots that will represent the Transformed Image 72 when it is printed on an article 40.

Advantageously, there is no need for traditional Raster Image Processing (RIP) operations whereby an image to be printed undergoes multiple processing steps, such as conversion to a PDL (Page Description Language) file prior to printing. Instead, the Transformation Unit 70 directly converts each New Image 65 received from the New Image store 64, such as a PNG file in RGB (red, green, blue) contone color format, into a Transformed Image 72 (a halftone raster image in CMYK color format) that is ready for print head specific formatting and printing.

When a New Image 65 is received by the Transformation Unit 70, a Scaling operation 74 may be performed that resizes the image to fit within the boundary of the measured article 40 (typically with some amount of buffer spacing between the edge of the image and the edge of the article, as previously noted). The Transformation Unit 70 may then perform a Rotation operation 76 that rotates the image according to the angular orientation of the article. The Transformation Unit 70 may then perform a Screening operation 78 that implements an image-converting screening transformation to pixelize non-broken continuous tone (contone) data in a New Image 65 (typically a PNG file or the like created for electronic display using a three-color RGB color format) in order to create a four-color CMYK raster image whose pixels define discrete halftones for each of the cyan, magenta, yellow and black colors to be printed. The Transformation Unit 70 may also perform a Masking operation 80 that masks edge portions of the image where the printed surface height of the article 40 may drop off around the article edges. The masking operation 80 may be used to lower the pixel density or ink drop size at such edge portions in order to fade the image at it periphery and thereby mask any image distortions that might otherwise be noticeable due to the edge height drop off. A Customization operation 82 may include one or more additional operations that can be used to improve image quality when printed on the article 40.

Each Transformed Image 72 prepared by the Transformation Unit 70 may take one or two pathways after leaving the Transformation Unit, depending on whether the Transformed Image is generated by the Learn Procedure 42 operating on a single test article 40, or by the Printing Procedure 44 operating on successively-scanned articles to be printed.

In the case where the Transformed Image 72 is generated during the Learn Procedure 42, the Transformed Image is stored in the Image Cache 68 for future fast path processing during the Printing Procedure 44. In addition to storing the Transformed Image 72 in the Image Cache 68, the Transformed Image may be test-printed. In that case, the Transformed Image may be sent to a Formatter 84 that performs additional formatting on the Transformed Image to ensure compatibility with the manufacturer-specific print head module, and thereafter printed.

In the case where the Transformed Image 72 is generated during the Printing Procedure 44, the Transformed Image may or may not be placed in the Image Cache 68. It is thus possible to bypass the Image Cache 68 and forward the Transformed Image 72 directly to the aforementioned Formatter 84. Alternatively, each newly Transformed Image 72 may be placed in the Image Cache 68 for printing subsequent articles 40 while also being directed to the Formatter 84 for printing.

### Fast Path Processing

The fast path represented by the upper pathway 66 emanating from the Scanner utilizes previously Transformed Images 72 stored in the Image Cache 68 for article printing. During fast path processing, the Transformation Unit 70 has already generated the Transformed Image 72 and placed it in the Image Cache 68 at the time of printing. When the Printing Procedure 44 prints using a Transformed Image 72 that is already resident in the Image Cache 68, the only measurement data needed from the Scanner 50 are the article height measurement and the X-offset and Y-offset measurements representing the offset from the center of the scanned article's virtual containment object (as specified by the article's Shape parameter 60) to the center of the article profile scanner 6. This offset information is used to reposition the center of the Transformed Image 72 within the raster Image Cache 68 (whose geometry maps to the geometry of the print head module 18). Following this positioning adjustment, the Transformed Image 72 is sent to the previously-described Formatter 84.

It will be appreciated that the Printing Procedure 44 may utilize a combination of fast path and slow path image processing. For example, when the Printing Procedure 44 is invoked on one or more New Images 65 in the New Image store 64, the Control System 10 may perform slow path processing as it encounters each New Image, utilizing the Transformation Unit 70 to covert each New Image into a Transformed Image 72, and then forward the Transformed Image to the Formatter 84 while also storing it in the Image Cache 68 (as noted above). Thereafter, any subsequent articles 40 to be printed with the same image can be printed using the fast path upper pathway 66 through the Image Cache 68.

Regardless of which pathway is taken, the article height measurement information processed by the Scanner 50 will be used to adjust the height of the print head module 18 in order to position the ink jet print heads 22 at the desired spacing distance from the article 40. In a typical production scenario, the articles 40 being printed will all have a fairly uniform height. In that case, the print head height may be set when the first article 40 is scanned by the article profile scanner 6. Height measurements obtained from subsequent articles 40 may thereafter be used to detect outlier articles whose height is so high that a head crash into the print heads 22 might result. In that case, the height measurement of the outlier article 40 may be used to perform an emergency halt of the conveyor 20. For example, an emergency halt may be triggered if the article height is such that the spacing distance of the print head 22 falls below a predetermined distance (e.g. 0.070 inches). It is also possible to perform periodic fine tuning adjustments of the height of the print head module 18 as the Printing Procedure 44 proceeds, in some cases even on an article by article basis.

With continuing reference to FIG. 11, the Formatter 84 is manufacturer specific and thus will vary from one print head module 18 to the next. Example operations performed by the Formatter 84 include pixel realignment and other hardware-specific transformations. The resultant images will be referred to as Formatted Images 85.

Formatted Images 85 produced by the Formatter 84 are sent to an array of Format Buffers 86 to await submission to the print head module 18. FIG. 11 illustrates several Format Buffers 86, each of which may contain Formatted Image data for the two colors to be printed by a single head pair 48 of ink jet print heads 22 for a particular Formatted Image 85. The contents of one Format Buffer 86 may be sent to the Head 1 head pair 48 and the contents of another Format Buffer may be sent to the Head 2 head pair. Two Format Buffers 86 may thus be used for printing each Formatted Image 85. FIG. 11 illustrates the use of four Format Buffers 86 to signify that two Formatted Images 85 may be buffered at the same time, thus allowing different Formatted Images to be printed on different articles 40. Additional Format Buffers 86 could be added according to print production requirements. As previously noted, the printing apparatus 2 supports the printing of successive images of varying subject matter to be printed on successive articles 40.

As additionally shown in FIG. 11, Formatted Image data sent to each head pair 48, may pass through a Data Stream Buffer 88 to a Print Head Driver 90 that controls print head operations for the ink jet print heads 22 of each head pair. The print heads 22 of each head pair 48 will thus be driven to faithfully lay down ink patterns in their respective colors (i.e., C or M for Head 1 and Y or K for Head 2). In this way, each article 40 passing under the print head module 18 will be printed with a particular Formatted Image 85.

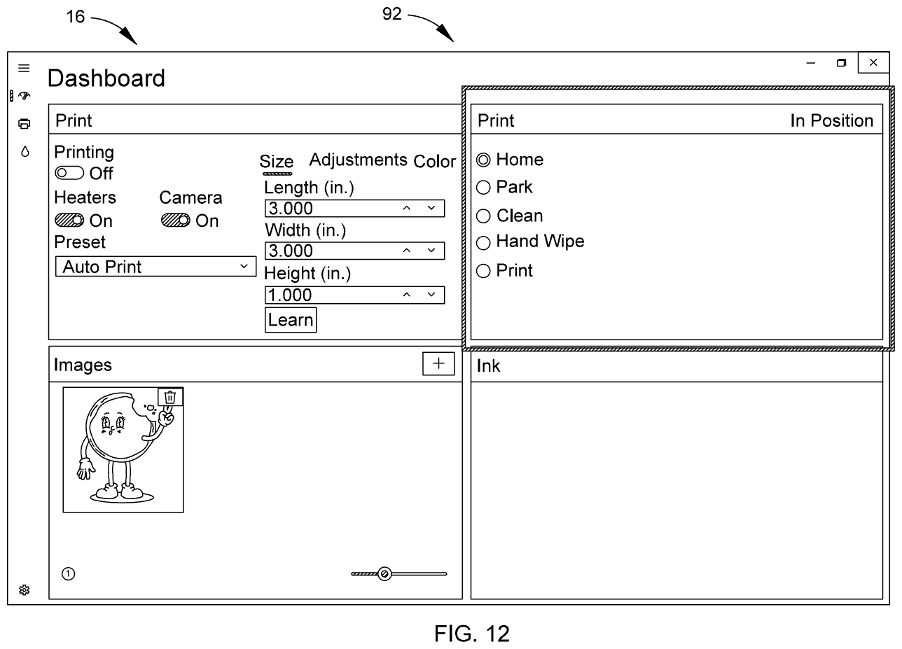

Turning now to FIG. 12, as screenshot of the operator control panel 16 implementing a Dashboard Interface 92 is shown. In FIG. 12, the Dashboard Interface 92 is divided into four regions that are respectively labeled “Print,” “Motion,” “Images” and “Ink.” FIG. 12 highlights the “Motion” region, which provides information about the motions of the print head module 18 and the ink collection (a.k.a., cleaning) tray (if an ink collection tray is present). In the Home position, the print head module 18 is up and the ink collection tray is out of the way. This is the first step to get the print heads 22 into a printing position. In the Park position, the print head module 18 is on the ink collection tray and sealed to keep the ink jet print heads 22 from drying out. The Park position is used when printing is finished to prevent extra cleaning steps. The Clean position is used for a Cleaning Mode where the print heads 22 are wiped down and re-parked. To get to the Clean Mode, the print head module 18 is first placed in the Park position. In the Hand Wipe position, the print heads 22 descend from a housing box of the print head module 18 enough to be hand wiped. The Print position is the operational print position.

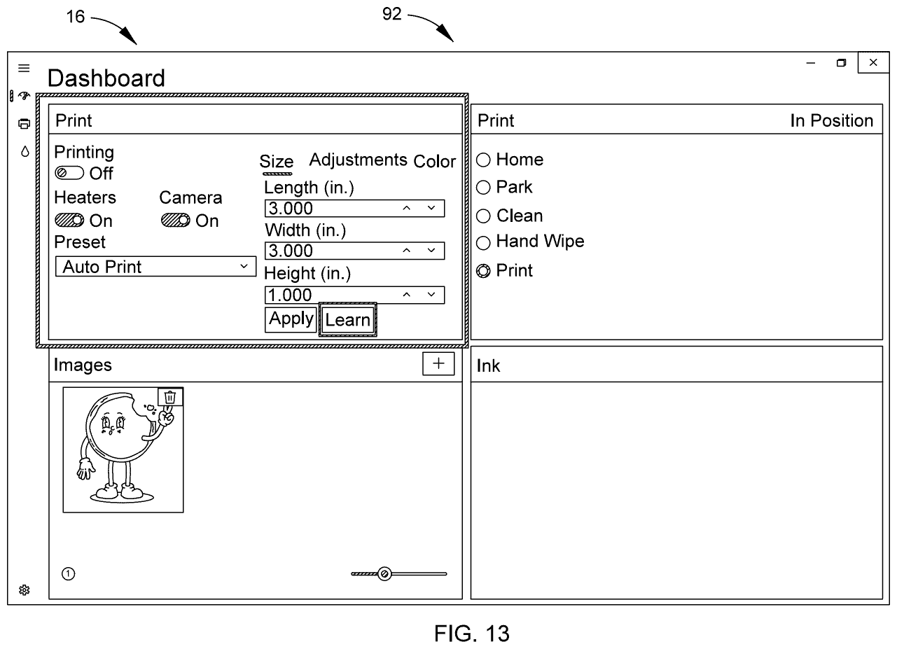

Turning now to FIG. 13, a screenshot of the operator control panel 16 is shown to highlight information that may be provided in the “Print” region of the Dashboard Interface 92. The Print region of the Dashboard Interface 92 is where the operator specifies what the printing apparatus 2 is to print. It includes a Printing control slider that is depicted as being turned off, but can be switched on to initiated printing. There is also a Heater control slider that operates a heater built into the print head module 18 to keep the inks at an optimal temperature. It is recommended to leave the heaters on, and this state is shown in FIG. 13. There is also a Camera control slider that activates the article profile scanner 6 in order to detect the position of articles 40 on the conveyor 20. It is recommended to leave the article profile scanner 6 on, and this state is shown in FIG. 13. An Auto Print preset may be selected to reveal a saved image in the Images region of the Dashboard Interface 92. There are also various image settings that can be accessed using the illustrated Print region sub-menu. These image settings include a Size setting that may be used by an operator to manually specify the length, width and height dimensions of the articles 40 to be printed. Alternatively, the operator may select the “Learn” option to initiate the Learn Procedure 42, then place a test article 40 on the conveyor 20 to allow the article profile scanner 6 to determine the length, width, and height measurements of the article. As further described below, there is also an Adjustments setting that allows the operator to make specific image adjustments, and a Color setting that enable the operator to adjust the CMYK values of a Transformed Image 72 to be printed.

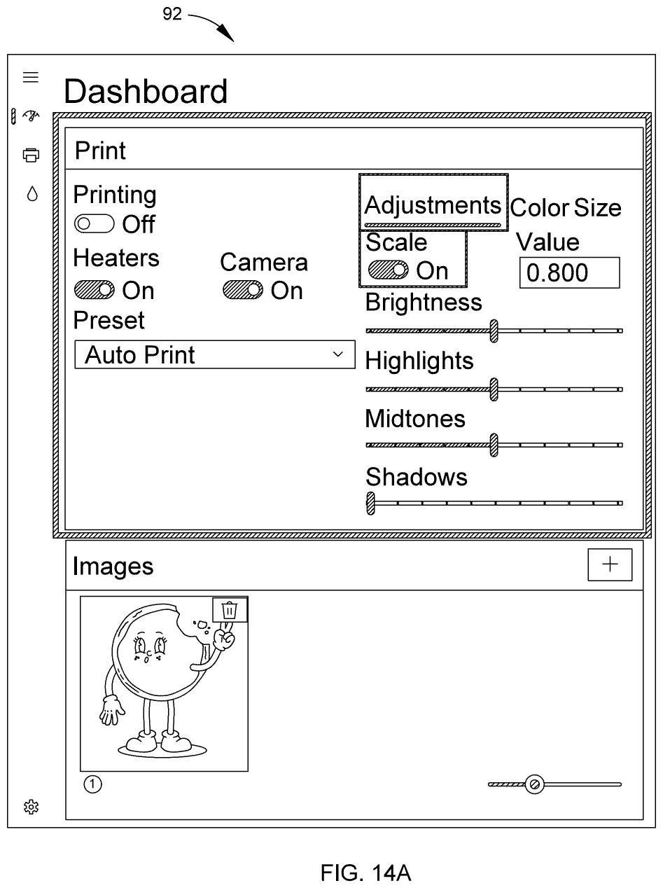

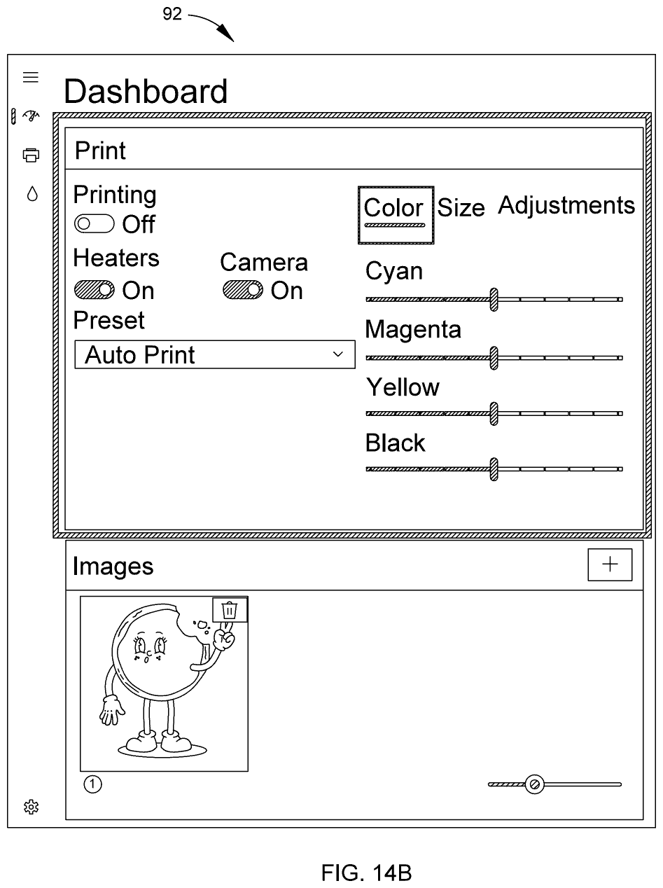

Turning now to FIGS. 14A and 14B, the Adjustment and Color settings shown in FIG. 13 are enumerated. In FIG. 14A, the Adjustments settings include a Scale control slider that when activated allows an operator to enter a scaling ratio value representing a scaling ratio applied to a Transformed Image 72 to be printed. The Adjustment settings further include Brightness, Highlights, Midtones, and Shadows control sliders. These control elements give the operator more control over fine adjustments. In an embodiment, the Adjustment sliders may move in increments of +/−20%. In FIG. 14B, the Color settings include CMYK color slider controls for adjusting the CMYK colors of the Transformed Image being printed. In an embodiment, the Color sliders may move increments of +/−20%.

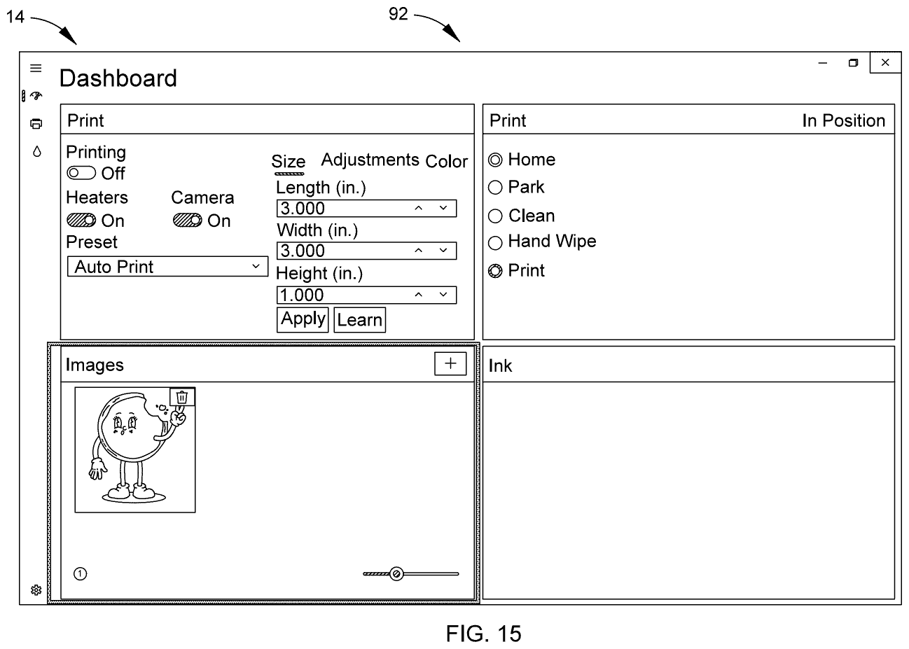

Turning now to FIG. 15, a screenshot of the operator control panel 16 is shown to highlight information that may be provided in the “Images” region of the Dashboard Interface 92. The Images region of the Dashboard Interface 92 is where an operator can view and adjust the size of previously selected images, and add new images from a local or remote data store (such as a local or network drive).

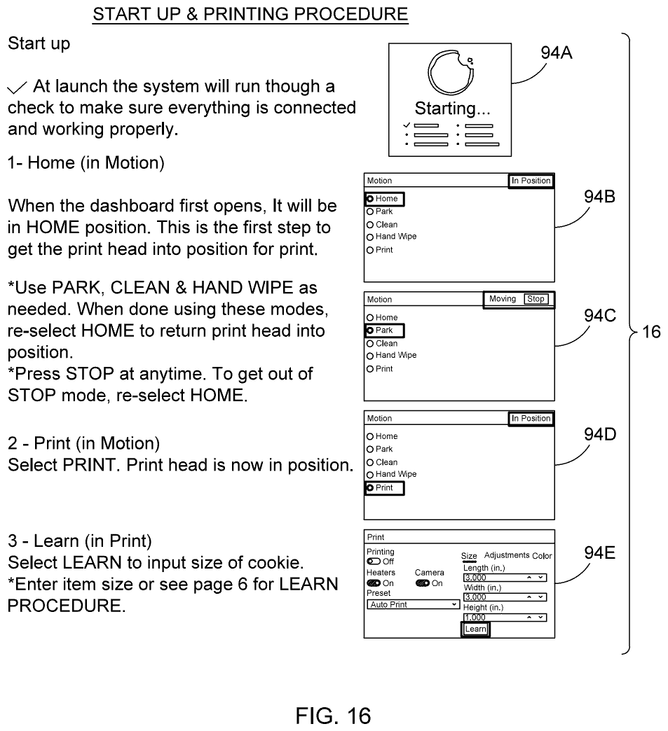

Turning now to FIG. 16, multiple screen shots of the operator control panel 16 are shown to highlight a Start Up & Printing Procedure 94 representing an example sequence of startup, initialization and Print Procedure operations of the printing apparatus 2. The Start Up graphic 94A at the top of FIG. 16 may be displayed at system launch as the printing apparatus 2 runs through a check to make sure all systems are connected and working properly. The next lower Home graphic 94B of FIG. 16 may be displayed when the Dashboard Interface 92 first opens. In particular, the Motion region of the Dashboard Interface 92 will indicate that the print head module 18 is in the Home position, which is the default position following system startup and initialization. This is the first step to get the print heads 22 into position for printing. As previously described, the Park, Clean and Hand Wipe options may be selected as needed. By way of example, the next lower Park, Clean & Hand Wipe graphic 94C of FIG. 16 shows that the Park mode has been activated in order to Park the print head module 18 following printing. As this is occurring, the upper right hand corner of the Motion region alerts the operator that the print head module 18 is moving. At any time during movement of the print head module 18, the operator may press “Stop” to halt the movement. To exit the Stop mode, the operator may re-select the Home option. Following the implementation of any modes other than the Home mode, the operator may re-select the Home option to return the print head module 18 into its home position. The next lower Print graphic 94D of FIG. 16 shows activation of the Print option. This will move the print head module 18 into its printing position. The lowermost Learn graphic 94E of FIG. 16 depicts the Learn Procedure initiation control button located in the Print region of the Dashboard Interface 92 (as previously described).

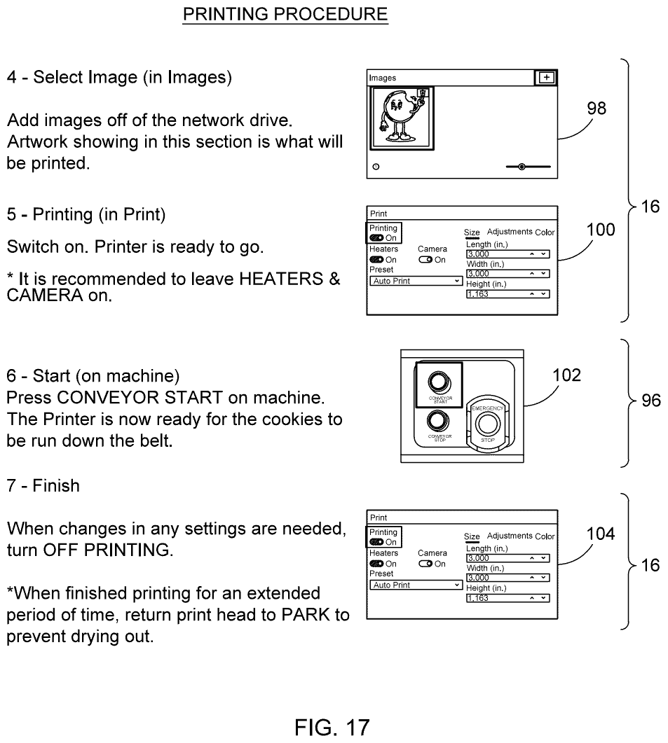

Turning now to FIG. 17, screenshots of the operator control panel 16 and a Power On/Power Off control panel 96 of the printing apparatus 2 are shown to highlight the Printing Procedure 44 of the printing apparatus. The Select Image graphic 98 at the top of FIG. 17 shows the Images region of the Dashboard Interface 92 depicting an image to be printed. The next lower Printing graphic 100 of FIG. 17 shows that the Printing slider control in the Print region of the Dashboard interface has been placed in the “On” position. At this point, the Heaters and Camera control sliders should have also been previously placed in their “On” positions. The next lower Start graphic 102 of FIG. 17 depicts the Power On/Power Off control panel 96, with Conveyor Start and Conveyor Stop power buttons for starting and stopping the conveyor 20. The Power On/Power Off control panel 96 may also include an Emergency Stop button that immediately shuts down the conveyor 20 and halts operation of the printing apparatus 2. The next lower Finish graphic 104 of FIG. 17 shows the Printing slider control in the Print region of the Dashboard Interface 92. When printing has completed, this slider is moved to the “Off” position. If printing will not resume within a relatively short time period, the operator may use the Motion region of the Dashboard interface to park the print head module in the Park position to prevent the inks from drying out.

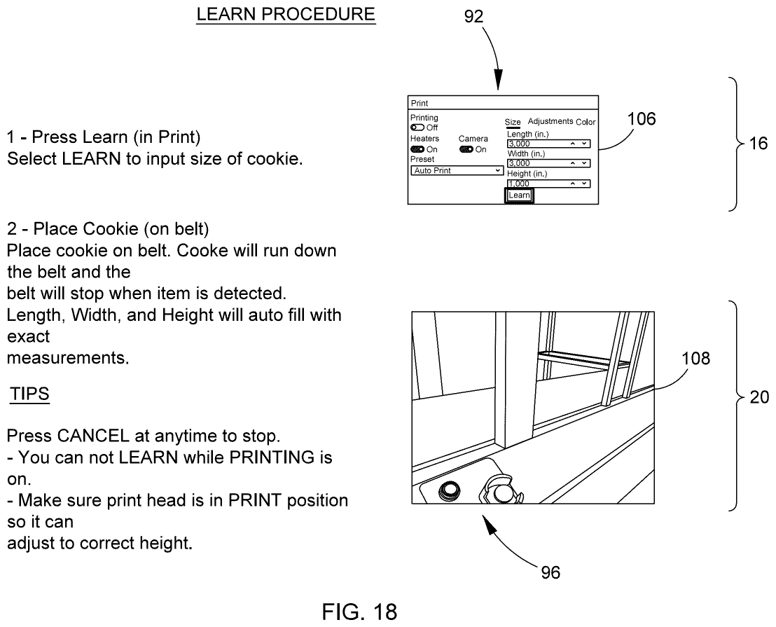

Turning now to FIG. 18, a screen shot of the operator control panel 16 and a depiction of the conveyor 20 are shown to highlight the Learn Procedure 42. The Press Learn graphic 106 at the top of FIG. 18 shows the previously-described Learn button in the Print region of the Dashboard Interface 92. To implement the Learn Procedure 42, the operator activates the Learn button and places a test article 41 on the conveyor 20 upstream of the article profile scanner 6. This is shown in the Place Cookie graphic 108. The Print Mode option should be selected in the Motion region of the Dashboard Interface 92. The operator then places an article 40 on the conveyor 20 and the conveyor belt 36 runs the article under the article profile scanner 6. The conveyor 20 will halt after the article 40 has been detected. The detected length, width and height of the article 20 will be auto-filled in corresponding fields in the Print region of the Dashboard Interface 92. The operator may interact with the conveyor the Power On/Power Off control panel 96 if it is desired to cancel the Learn Procedure 42. As previously described, the measurements of the test article 40 are used by the Transformation Unit 70 of FIG. 11 to transform the selected image into a Transformed Image 72 in CMYK raster image format, which is then stored in the Image Cache 68. The height of the print head module 18 is also adjusted based on the article's measured height.

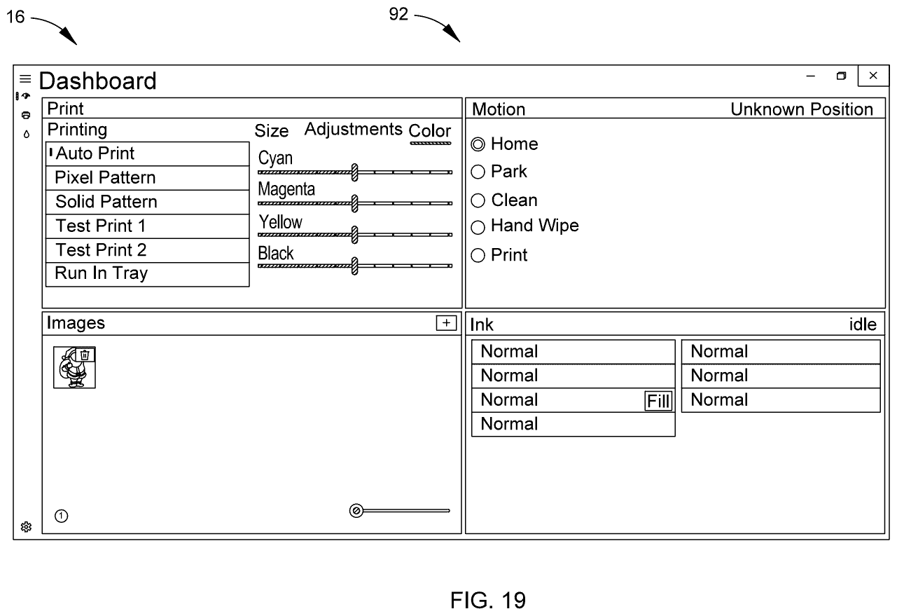

Turning now to FIG. 19, various test print options are shown in the Print region of the Dashboard Interface 92 are shown. These options allow a technician to perform advanced image color change operations on the printing apparatus 2, such as adjusting the ICC color profile of a Transformed Image 72 (as transformed by the Transformation Unit 70 of FIG. 11) without editing the original image itself. Various test patterns may be printed for image evaluation purpose.

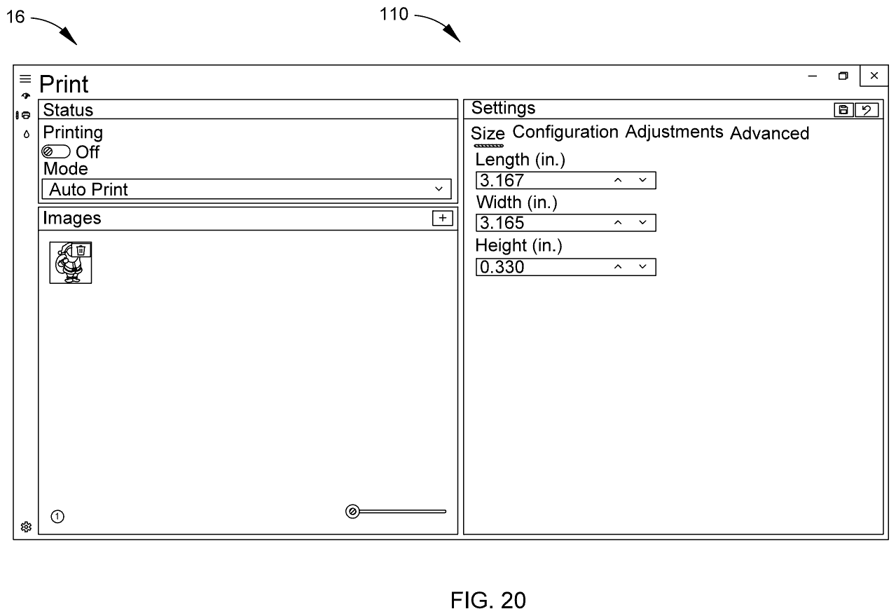

Turning now to FIG. 20, a Print Interface 110 of the operator control panel 16 is shown for use by a technician to perform advanced operations of the printing apparatus 2. The Print Interface 110 includes a “Status” region, a “Settings” region and an “Images” region. The Status region contains a Printing slider control and a mode sub-menu for selecting various print modes, which may include an Auto Print mode and various test print options, as shown in previous depictions of the Print region of the Dashboard Interface 92. The Settings region contains Size, Configuration, Adjustments and Advanced sub-menus, with the Size sub-menu being open for use by the technician. The Size sub-menu contains the same image size options that have been previously described. The Image region shows the image to be printed.

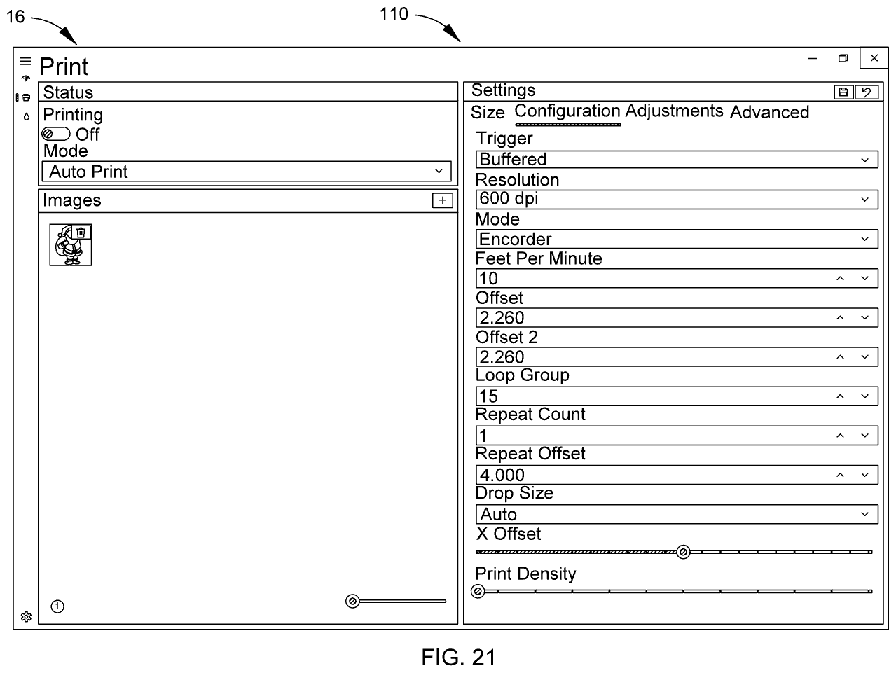

Turning now to FIG. 21, the Print Interface 110 of FIG. 20 is shown with the Configuration sub-menu of the Settings region being open for use. These configuration options pertain primarily to the conveyor 20 and its interaction with the print head module 18.

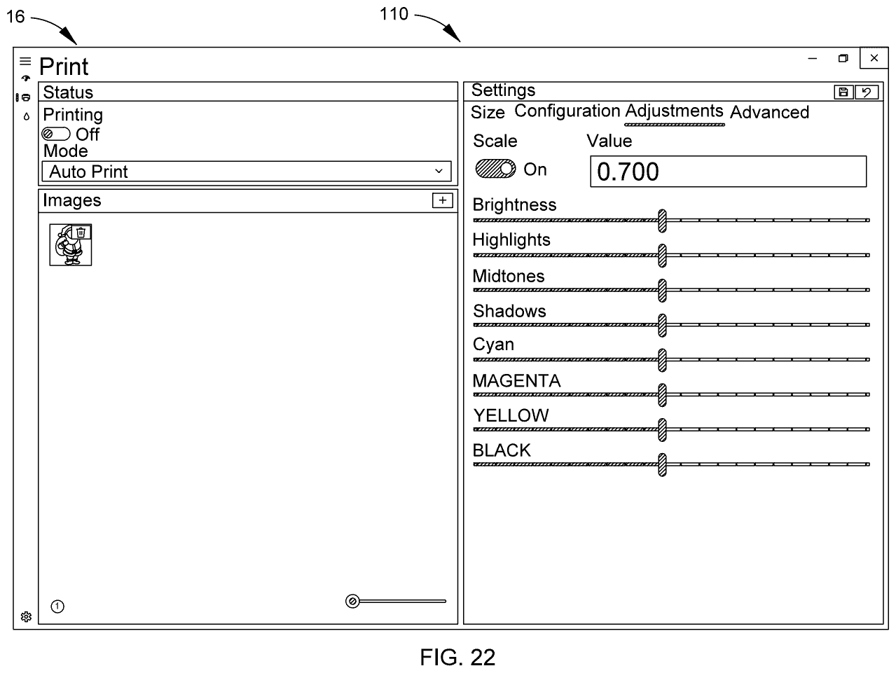

Turning now to FIG. 22, the Print Interface 110 of FIG. 20 is shown with the Adjustments sub-menu of the Settings region being open for use. These adjustment options pertain primarily to the images to be printed.

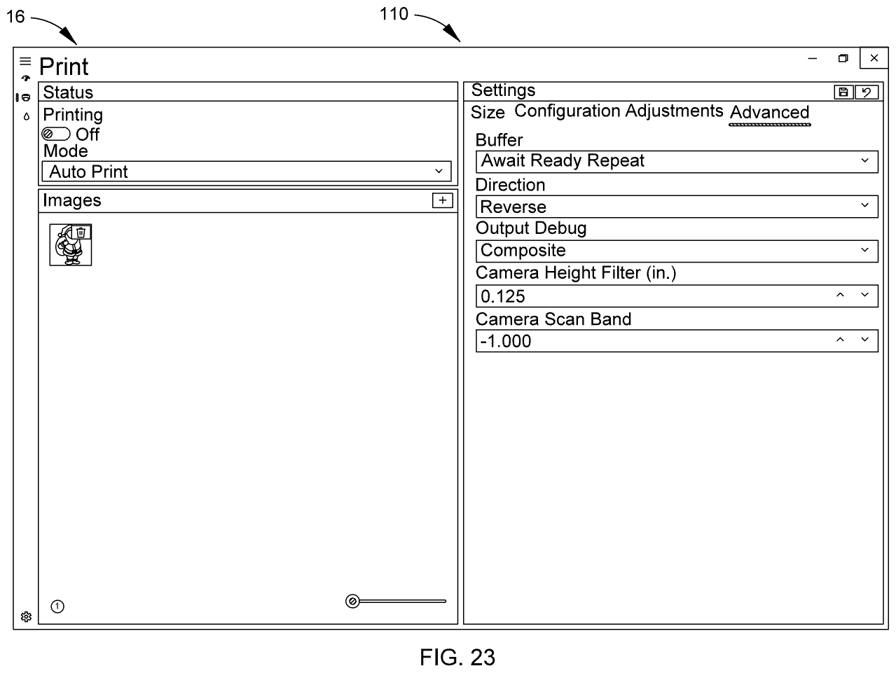

Turning now to FIG. 23, the Print Interface 110 of FIG. 20 is shown with the Advanced sub-menu of the Settings region being open for use. These adjustment options pertain primarily to the article profile scanner 6, the print head module 18 and debugging/testing features.

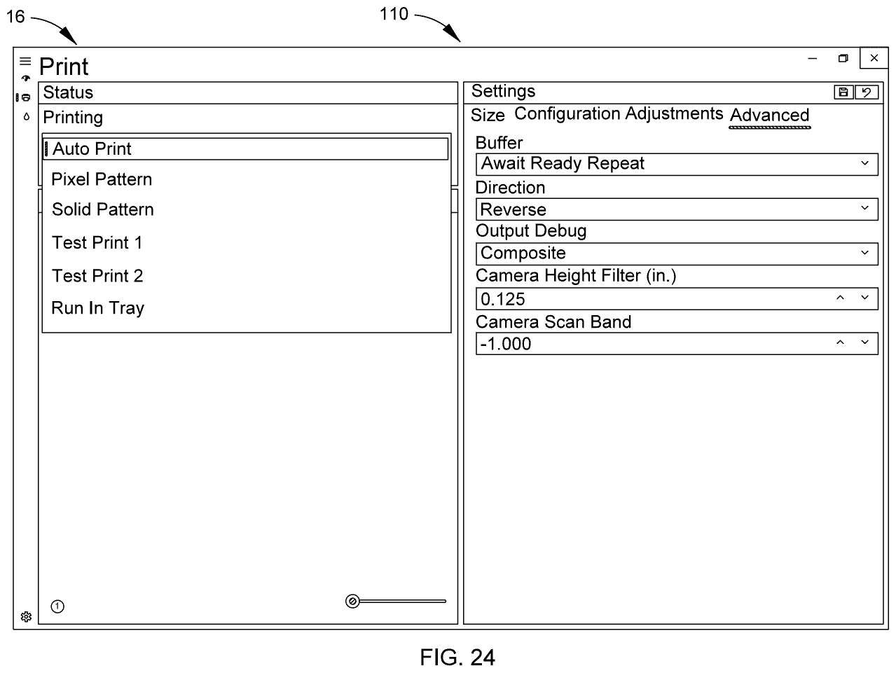

Turning now to FIG. 24, the Print Interface 110 of FIG. 20 is shown with the Status region mode sub-menu being open for use to allow testing of various image patterns.

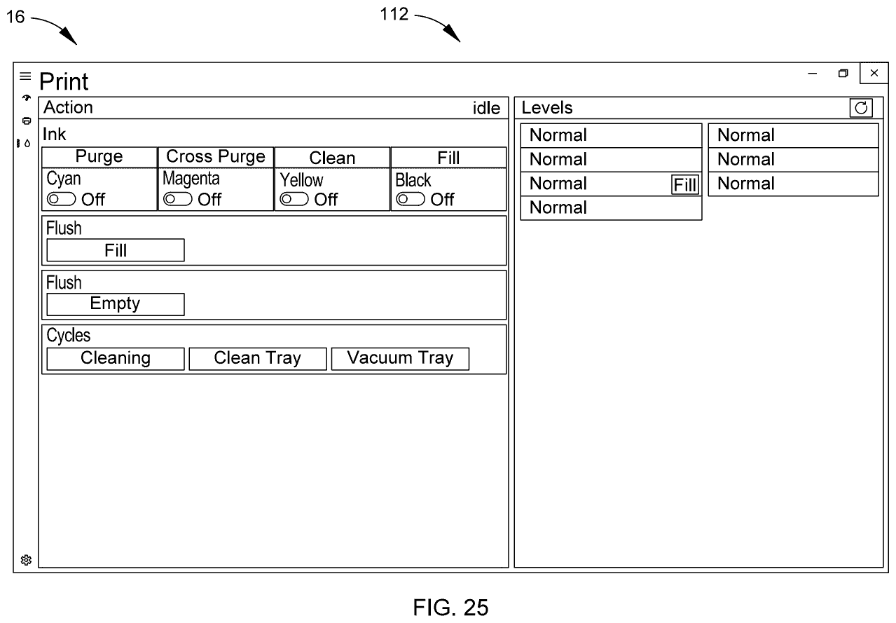

Turning now to FIG. 25, an Ink Supply Interface 112 of the operator control panel 16 is shown for use by an operator to interact with the ink supply station 8. The Ink Supply Interface 112 includes an Actions region and a Levels region. The Levels region indicates the ink level status of each ink module 26. The Actions region provides various options for manipulating the ink modules 26 in order to ensure the integrity of the ink supply.

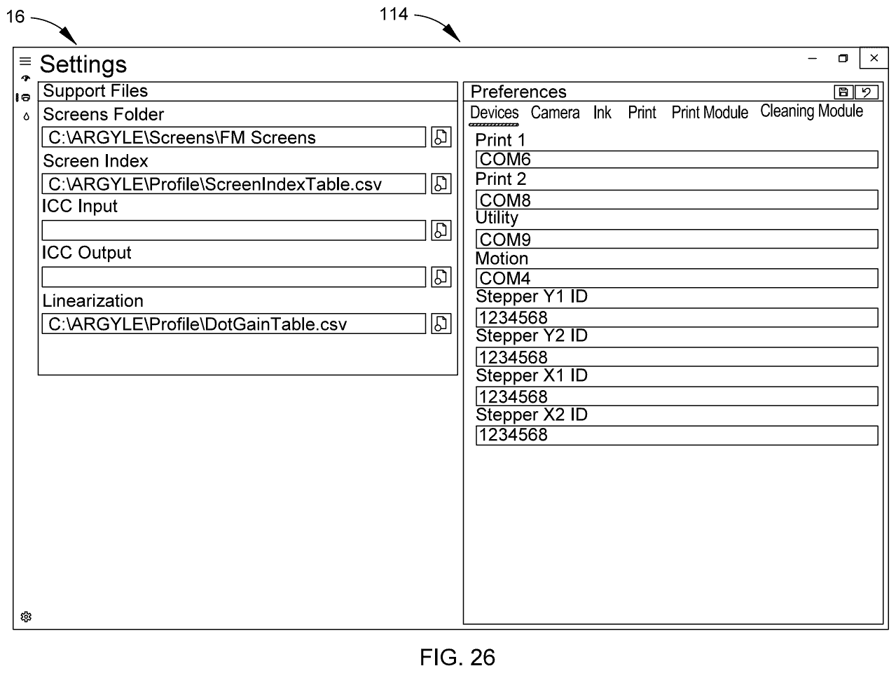

Turning now to FIG. 26, a Settings Interface 114 of the operator control panel 16 is shown for use by a technician to adjust certain global settings of the printing apparatus 2. The Settings Interface 114 includes a Support Files region and a Preferences region. The Support Files region specifies the file and directory path names of various support and configuration files used by the control System 10. The Preferences region contains sub-menus for identifying and in some cases specifying preference settings for certain components of the printing apparatus 2. In FIG. 26, a Device preferences sub-menu has been opened for inspecting and/or specifying certain device identification and communication port parameters.

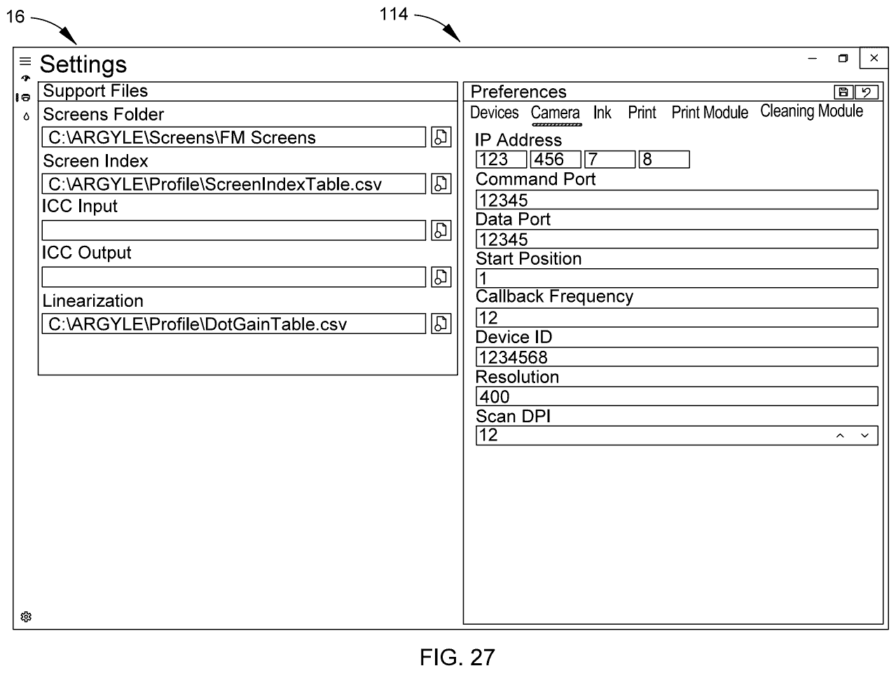

Turning now to FIG. 27, the Settings Interface 114 of FIG. 26 is shown with a Camera preference sub-menu open for inspecting and/or specifying various preferences associated with the article profile scanner 6.

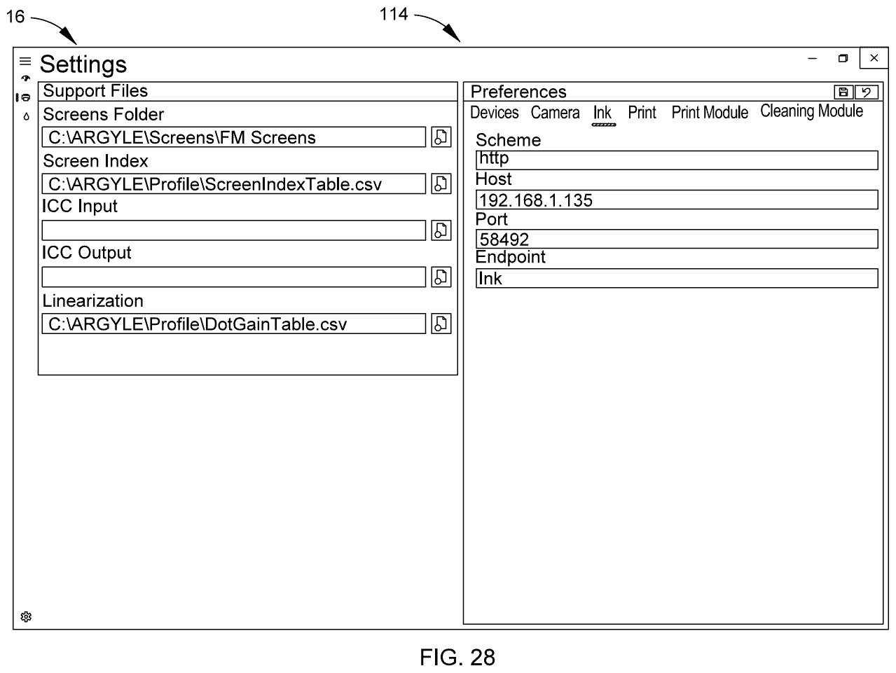

Turning now to FIG. 28, the Settings Interface 114 of FIG. 26 is shown with an Ink preference sub-menu open for inspecting and/or specifying various preferences associated with the ink supply station 8.

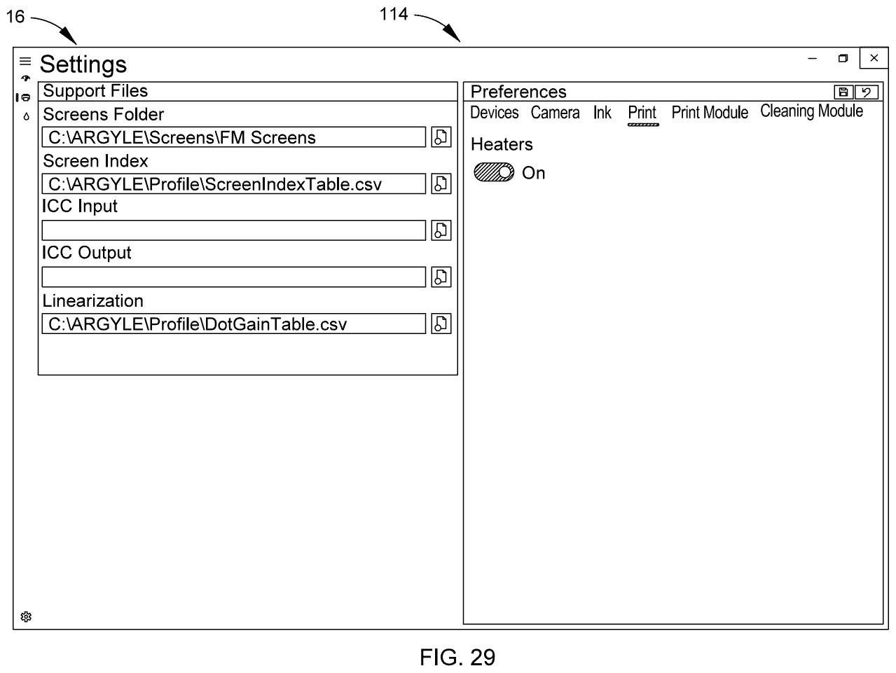

Turning now to FIG. 29, the Settings Interface 114 of FIG. 26 is shown with a Print preference sub-menu open for inspecting and/or specifying the status of the print head module's ink heaters.

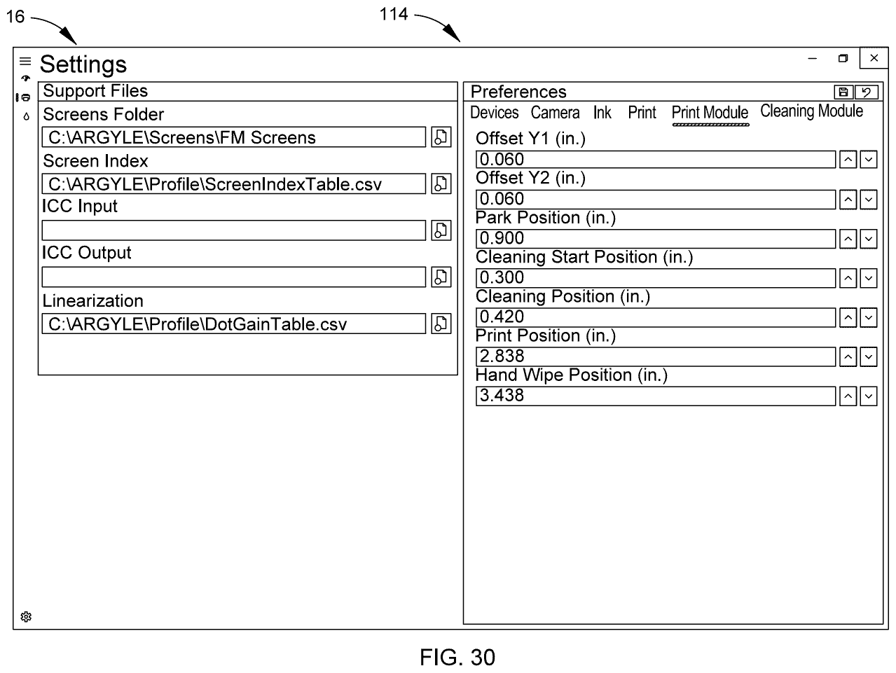

Turning now to FIG. 30, the Settings Interface 114 of FIG. 26 is shown with a Print Module preferences sub-menu open for inspecting and/or specifying various preferences associated with the print head module 18.

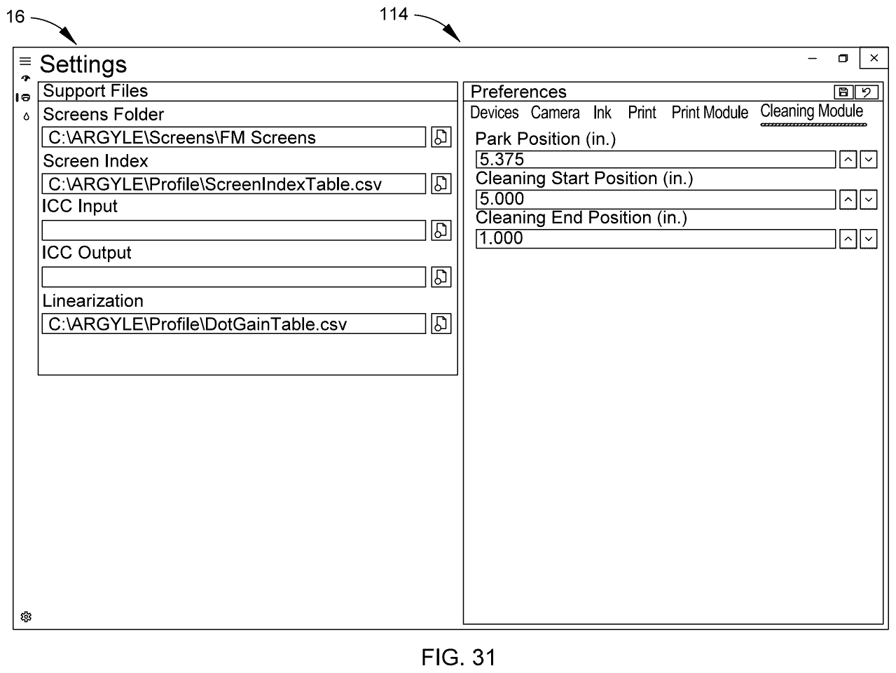

Turning now to FIG. 31, the Settings Interface 114 of FIG. 26 is shown with a Cleaning Module preferences sub-menu open for inspecting and/or specifying various preferences associated with the print head module's cleaning functionality.

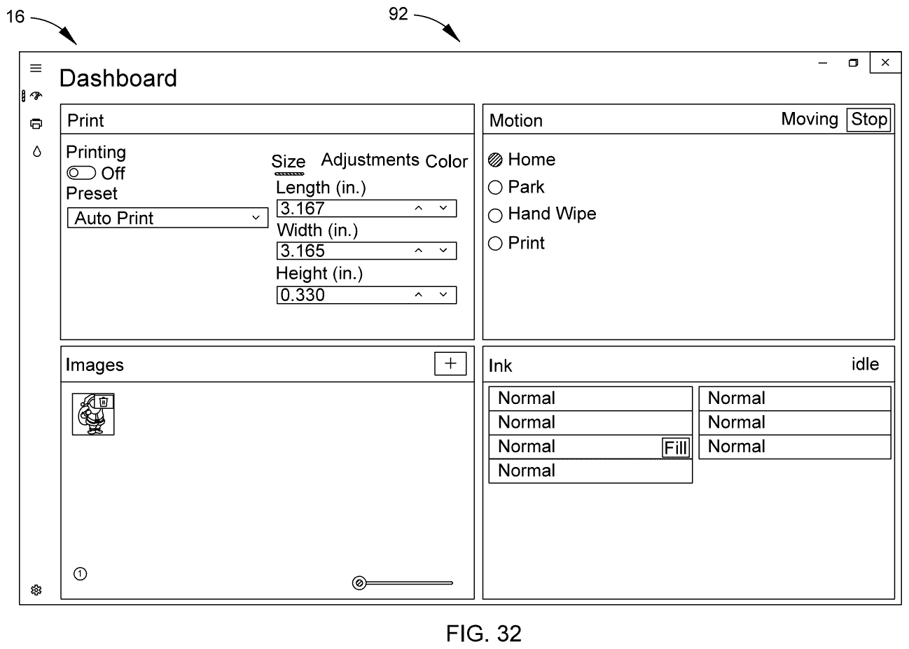

Turning now to FIG. 32, the Dashboard Interface 92 is shown to illustrate how the movement of the print head module 18 can be indicated to an operator in the Motion region.

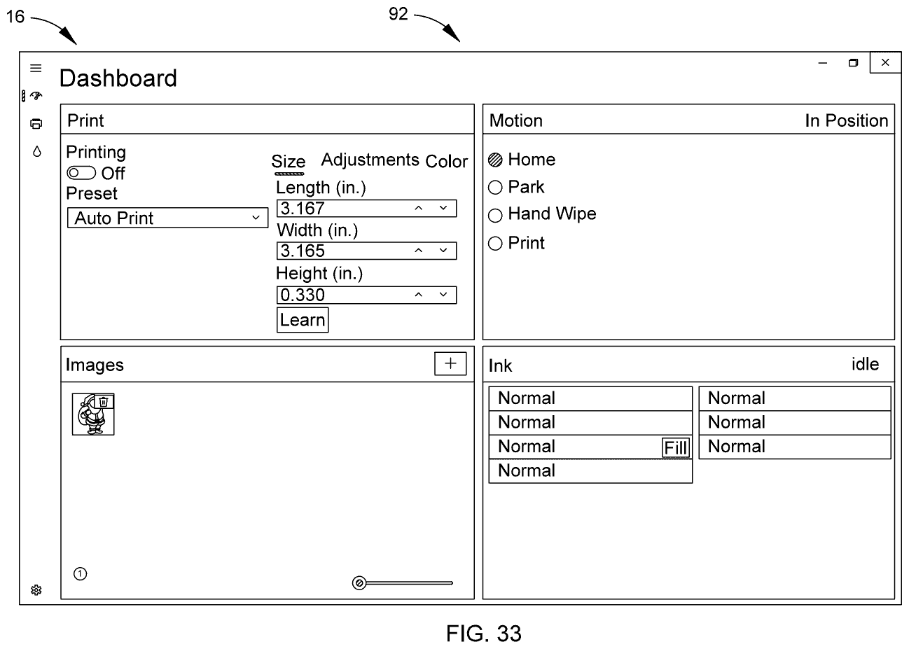

Turning now to FIG. 33, the Dashboard Interface 92 is shown to illustrate how the position status of the print head module 18 can be indicated to an operator in the Motion region.

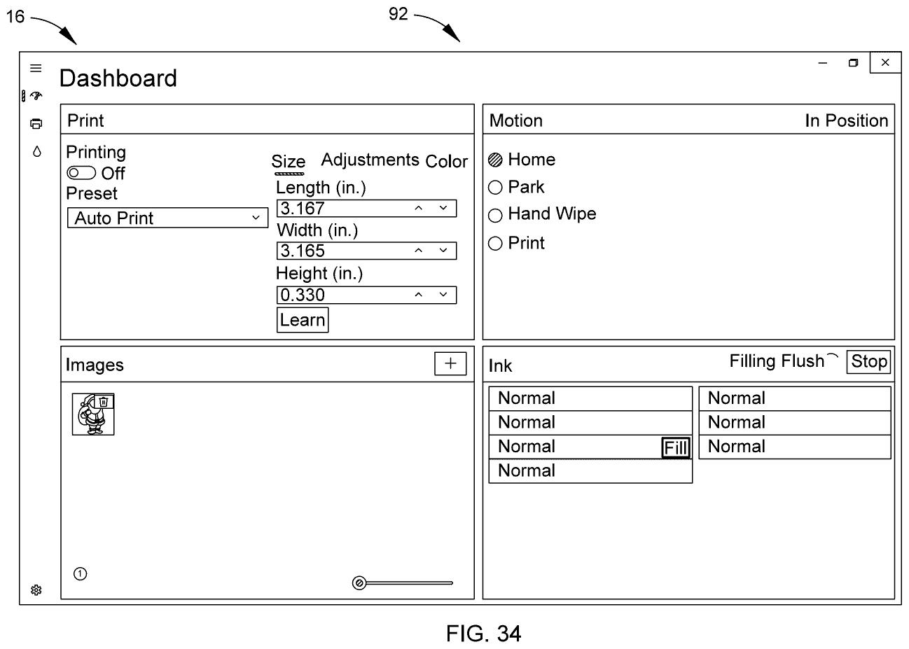

Turning now to FIG. 34, the Dashboard Interface 92 is shown to illustrate how the status of the ink supply station 8 can be indicated when a waste ink receptacle is full.

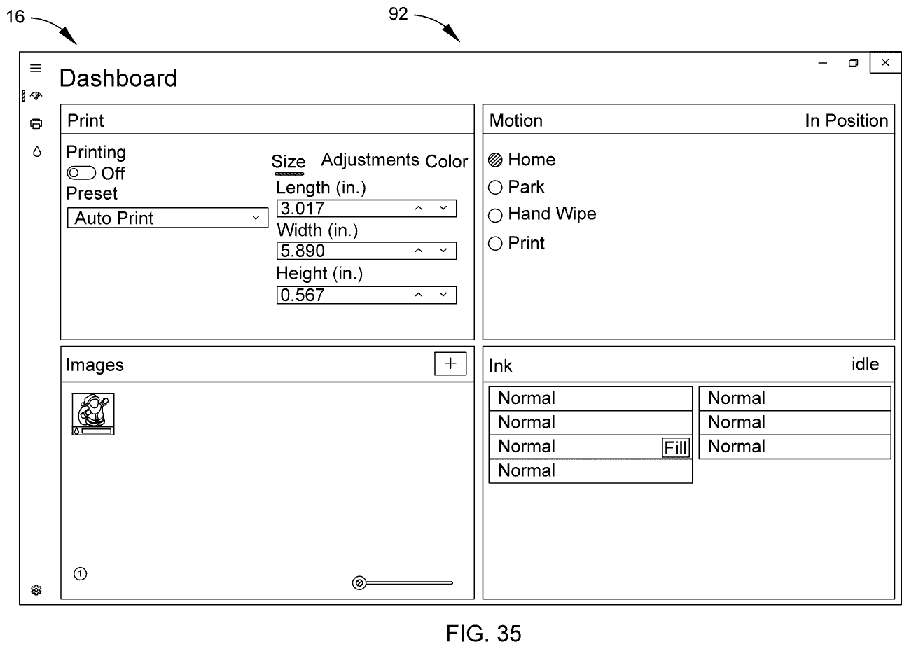

Turning now to FIG. 35, the Dashboard Interface 92 is shown to illustrate how the status of the ink supply station 8 can be indicated when ink levels are normal.

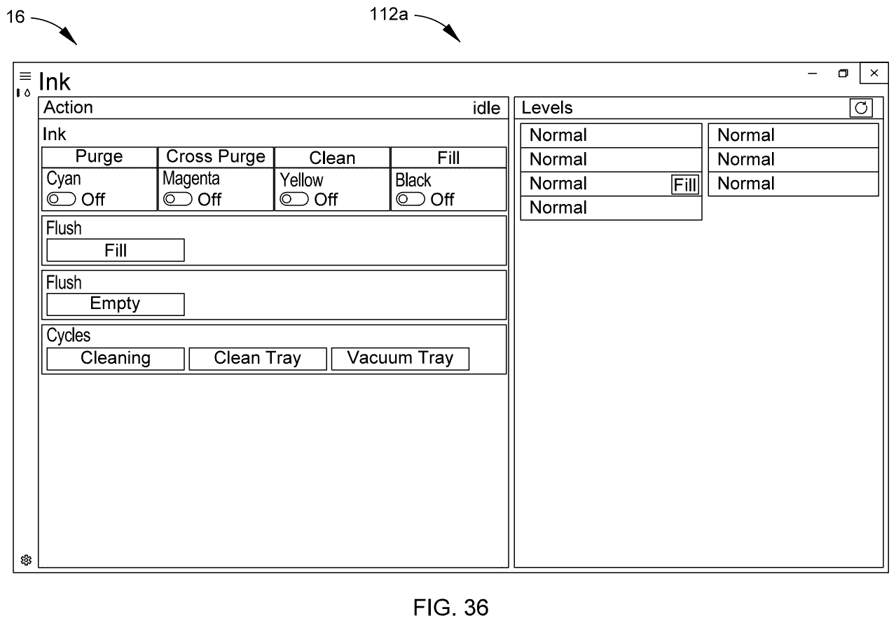

Turning now to FIG. 36, an alternate Ink Supply Interface 112a generated by the ink supply control system 34 is shown. The alternate Ink Supply Interface 112a is identical to the Ink Supply Interface 112 shown in FIG. 25. The difference is that the FIG. 25 Ink Supply Interface 112 is generated by the control System 10 of the printing apparatus 2 whereas the alternate Ink Supply Interface 112a is generated by the ink supply control system 34. The alternate Ink Supply Interface 112a provided by the ink supply control system 34 is a redundant ink supply interface. This redundancy allows the ink supply system 8 to be accessed in the event that the printing apparatus control System 10 is offline.

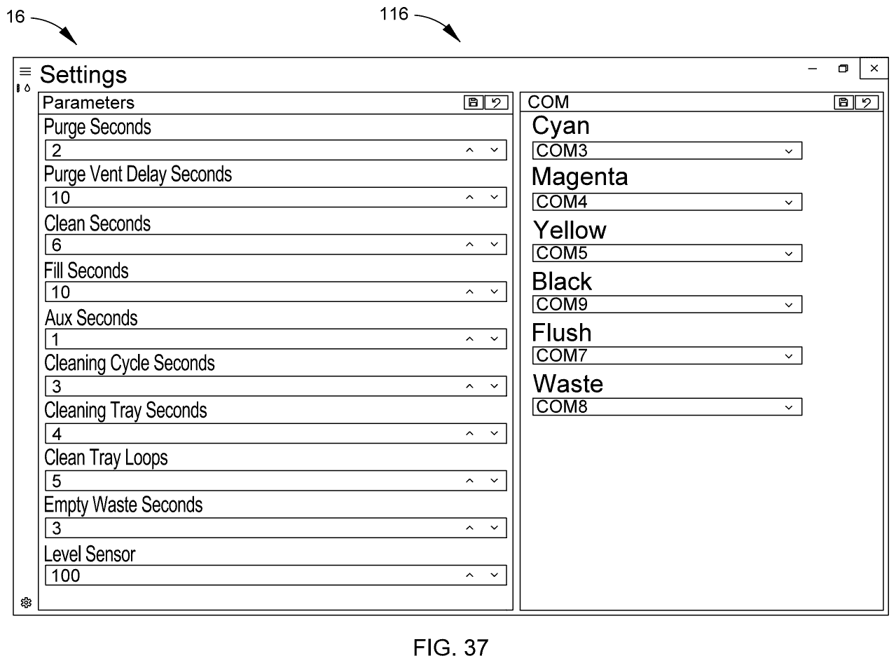

Turning now to FIG. 37, a Global Settings Interface 116 of the operator control panel 16 is shown for use by a technician to adjust certain global settings of the ink supply station 8. The Global Settings Interface 116 includes a Parameters region and a COM Region. The Parameters region allows adjustment of various ink purging, cleaning, filling and waste emptying parameters. The COM region identifies communication channels for interacting with the various ink modules 26 of the ink supply station 8.

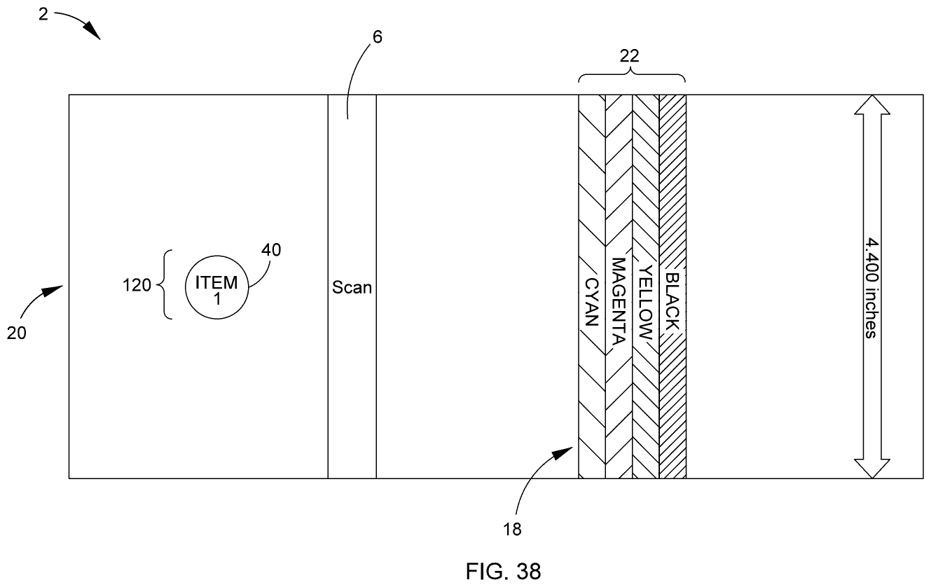

Turning now to FIG. 38, a diagrammatic plan view of the printing apparatus 2 depicts an embodiment wherein a single lane 120 of articles 40 on the conveyor 20 is scanned by the article profile scanner 6 and printed by the print head module 18, the latter being configured with ink jet print heads 22 having an example X-axis width of 4.4 inches. In this embodiment, the printing apparatus 2 has the capacity to print on articles 40 ranging in size up to 4.4 inches, representing the full print head width, with 0.75″ representing a typical minimum article size.

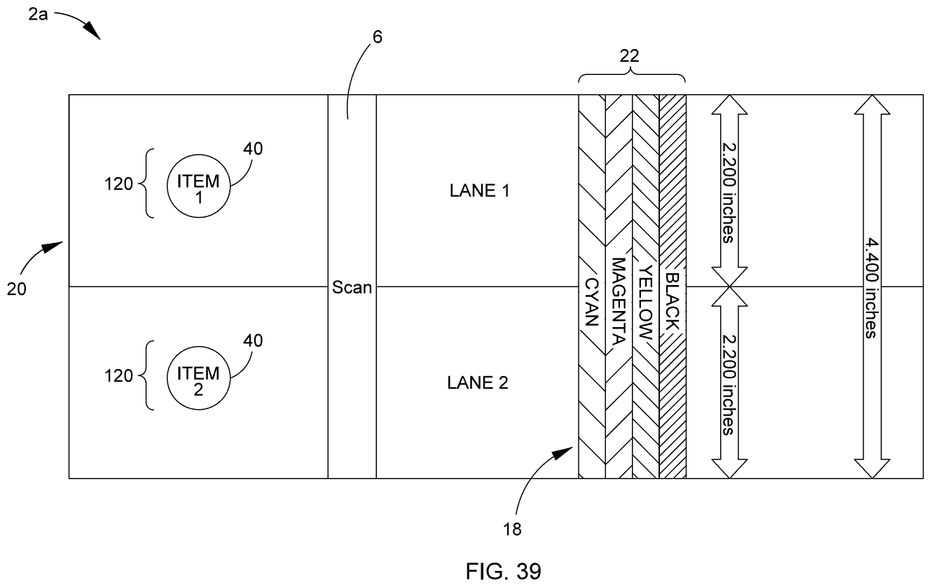

Turning now to FIG. 39, a diagrammatic plan view of a first alternative printing apparatus 2a depicts a larger-scale embodiment wherein two lanes 120 of articles 40 on the conveyor 20 are scanned by the article profile scanner 6 and printed by the print head module 18, the latter being configured with ink jet print heads 22 having an example X-axis width of 4.4 inches. In this embodiment, the first alternative printing apparatus 2a has the capacity to parallel print two articles 40 ranging in size up to the 2.2 inches, representing half the full print head width of 4.4 inches, with 0.75″ representing a typical minimum article size.

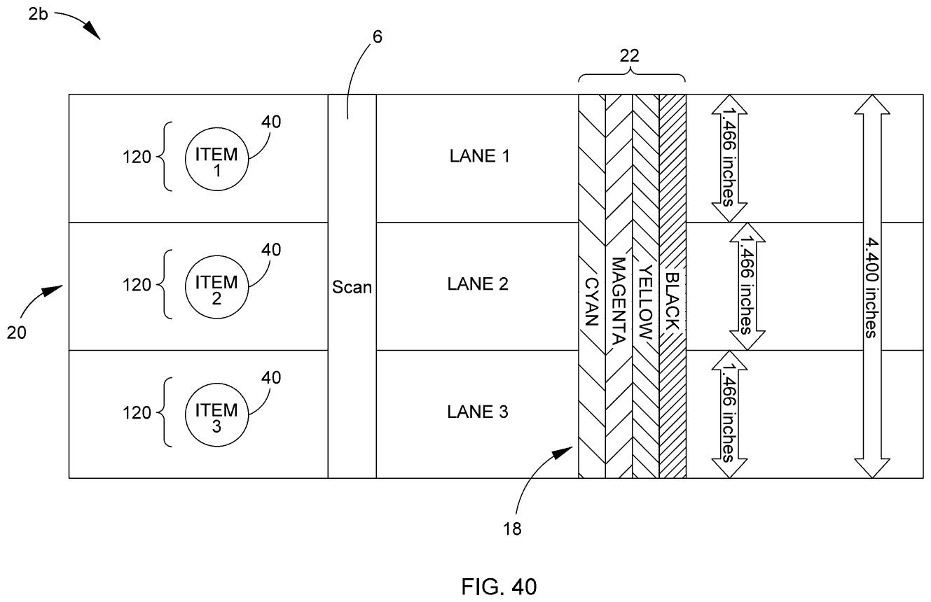

Turning now to FIG. 40, a diagrammatic plan view of a second alternative printing apparatus 2b depicts a still larger scale embodiment wherein three lanes 120 of articles 40 on the conveyor 20 are scanned by the article profile scanner 6 and printed by the print head module 18, the latter being configured with ink jet print heads 22 having an example X-axis width of 4.4 inches. In this embodiment, the second alternative printing apparatus 2b has the capacity to parallel print three articles 40 ranging in size up to the 1.466 inches, representing one third of the full print head width of 4.4 inches, with 0.75″ representing a typical minimum article size.

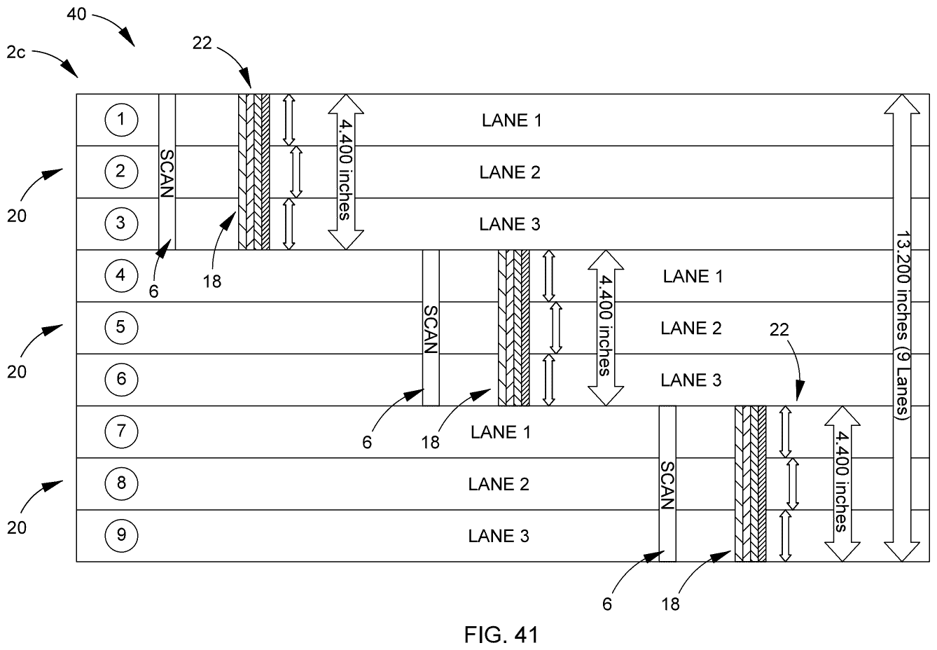

Turning now to FIG. 41, a diagrammatic plan view of a third alternative printing apparatus 2c depicts a still larger-scale embodiment wherein there is a stack of three of the multi-lane conveyors 20 of FIG. 40 running in parallel. Each conveyor 20 has its own article profile scanner 6 and print head module 18, and prints three lanes of articles. The three conveyors 20 may be situated in parallel adjacent relationship, with the article profile scanner 6 and print head module 18 of each conveyor being optionally staggered in the Y-axis direction to minimize the inter-conveyor spacing. This embodiment allows nine articles 40 to be printed in parallel.

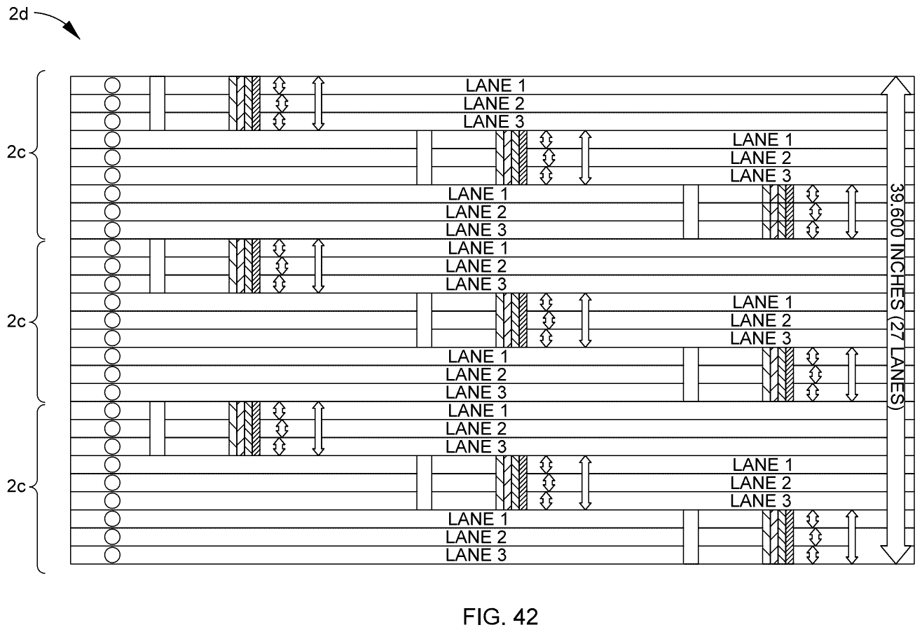

Turning now to FIG. 42, a diagrammatic plan view of a fourth alternative printing apparatus 2d depicts a still larger-scale production embodiment wherein there are three groups of the stacked three-conveyor printing apparatus 2c of FIG. 41, arranged in adjacent parallel relationship. This embodiment allows twenty-seven articles 40 to be printed in parallel.

The print capabilities of the embodiments shown in FIGS. 38-42 may be summarized as follows:
Single lane printing—0.750 to 4.400 inches product size
Double lane printing—0.750 to 2.200 inches product size
Triple lane—0.750 to 1.466 inches product size
Continuous Stack
   Stacks in groups of 3
      Three to nine lanes
Continuous Groups
   Nine stacks per group example: 3 groups×9 lanes=27 lanes
Scan Laser/Camera for multiple lane configurations.

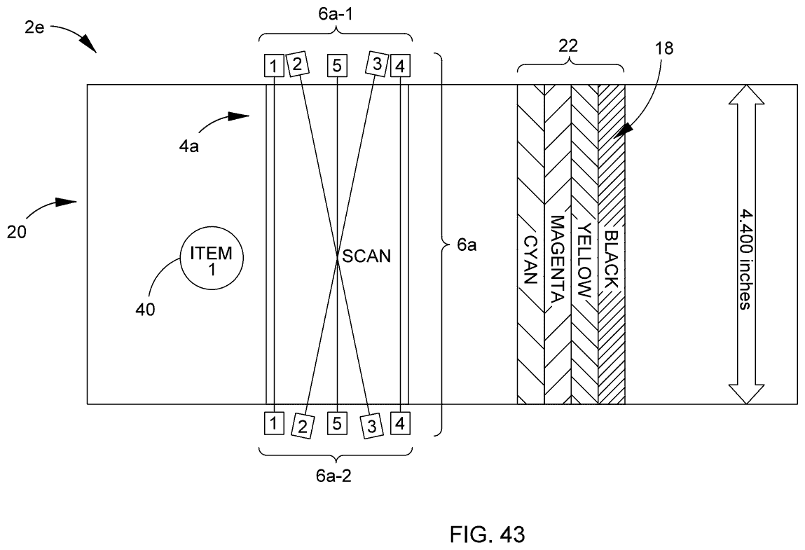

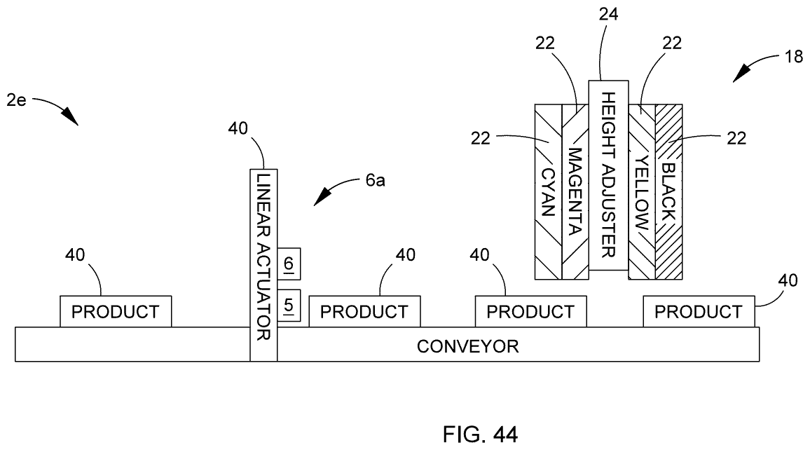

Turning now to FIGS. 43-45, a fifth alternative printing apparatus 2e designed for small scale production may be implemented as an embodiment wherein an alternative article profiling station 4a is used for single lane printing. The alternative article profiling station 4a uses an alternative 3D article profile scanner 6a that may be implemented using five low cost laser scanners (labeled 1-5). Each such laser scanner includes a laser transmitter 6a-1 on one side of the conveyor 20 and a laser sensor 6a-2 located across from the laser transmitter on the opposite side of the conveyor. The five (laser) scanners include a start scanner 1 having a transmitter/sensor pair 1-1 aligned in the X-axis direction, a left angle scanner 2 having a transmitter/sensor pair 2-2 aligned diagonally at an acute angle relative to the X-axis direction, a right angle scanner 3 having a transmitter/sensor pair 3-3 also aligned diagonally at an acute angle relative to the X-axis direction (with its light beam criss-crossing the beam of the left angle scanner 2), an end scanner 4 having a transmitter/sensor pair 4-4 aligned in the X-axis direction, and a height scanner 5 having a transmitter/sensor pair 5-5 aligned in the X-axis direction. As shown in FIG. 44, the alternative 3D article profile scanner 6a may also include height-to-high scanner 6 (see FIG. 44) having a transmitter/sensor pair 6-6 that is aligned in the X-axis direction.

As can be seen in FIG. 43, the start scanner 1 is located at the leading edge of the alternative 3D article profile scanner 6a. The end scanner 4 is located at the trailing edge of the alternative 3D article profile scanner 6a. As additionally shown in FIG. 44, the height scanner 5 and the height-to-high scanner 6 are located at the midpoint of the alternative 3D article profile scanner 6a. The left angle scanner 2 and the right angle scanner 3 are located between the midpoint of the alternative 3D article profile scanner 6a and the leading and trailing edges thereof.

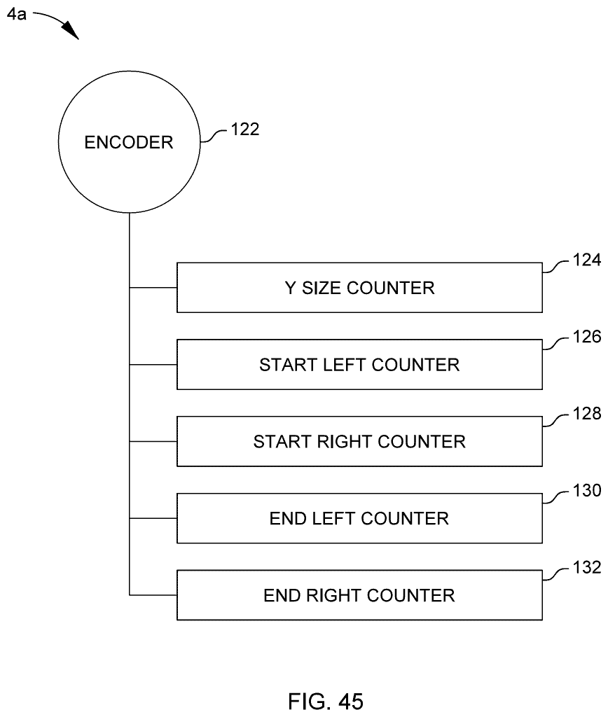

As shown in FIG. 45, the alternative article profiling station 4a of this embodiment further includes an encoder 122 and a set of counters that determine the Y-axis length, X-axis width and X-axis position of an article 40.

### Y-Axis Length Measurement

A Y-Size (length) Counter 124 outputs the number of encoder ticks elapsing from the start scanner 1 detecting the leading edge of the article 40 to the start scanner 1 detecting the trailing edge of the article. The encoder tick count equates directly to the Y-axis dimension of the article 40.

### X-Axis Width Measurement

The X-axis width measurement an article 40 may be determined directly from the Y-axis length measurement according to the article's Shape parameter. If the virtual containment object defined by the Shape parameter is a square, the X-axis width measurement will be equal to the Y-axis length measurement. If the virtual container object defined by the Shape parameter is a rectangle whose length and width dimensions are not equal, the X-axis width measurement will be the Y-axis length measurement multiplied by the width-to-length ratio of the virtual containment object. Similar relationships may be calculated for other shapes.

### X-Axis Position Measurement

A Start Left Counter 126 outputs the number of encoder ticks elapsing from the start scanner 1 detecting the leading edge of the article 40 to the left angle scanner 2 detecting the leading edge of the article.

A Start Right Counter 128 outputs the number of encoder ticks elapsing from the start scanner 1 detecting the leading edge of the article 40 to the right angle scanner 3 detecting the leading edge of the article.

An End Left Counter 130 outputs the number of encoder ticks elapsing from the left angle scanner 2 detecting the trailing edge of the article 40 to the end scanner 4 detecting the trailing edge of the article.

A Right End Counter 132 outputs the number of encoder ticks elapsing from the right angle scanner 3 detecting the trailing edge of the article 40 to the end scanner 4 detecting the trailing edge of the article.

The X-axis position measurement of an article 40 (at the article center) can be determined using the crossing times when the article enters and leaves the beams of the left angle scanner 2 and the right angle scanner 3, with the crossing times being indicated by the encoder ticks counted by the above-described counters 124-132. If the article 40 is centered on the conveyor 20 (as shown in FIG. 43), it will enter and leave the beams of each angle scanner 2 and 3 at the same time. If the article 40 is closer to the left edge of the conveyor 20 in FIG. 43, it will cross the beam of the left angle scanner 2 before it crosses the beam of the right angle scanner 3. If the article 40 is closer to the right edge of the conveyor 20 in FIG. 43, it will cross the beam of the right angle scanner 3 before it crosses the beam of the left angle scanner 2. Using these crossing times, the locations along each beam where the article 40 enters and leaves that beam may be determined. Trigonometry may then be used to determine the X-axis position of the article 20 along an imaginary X-axis line that bisects the angle between the two beams. In FIG. 43, this imaginary X-axis line happens to be the midpoint line along which the height scanner 5 is aligned.

### Z-Axis Height Measurement

As shown in FIG. 44, the height scanner 5 is used to measure the Z-axis height of the article 40. This may be done by adjusting the Z-axis position of the height scanner 5 using a linear stepper motor actuator 134 until the top of the article 40 breaks the beam. This marks the height of the article 40 from the top of the conveyor 20. The height of the print head module 18 may then be adjusted accordingly. The height-to-high scanner 6 is used as a shut-off sensor to prevent an abnormally high (rogue) article 40 from crashing the print heads 22. The height-to-high scanner 6 may be positioned at a Z-axis height representing a minimum safe distance from the print heads 22 (e.g., such as 0.070 inches below the print heads). If an article 40 thereafter breaks the beam of the height-to-high sensor 6, the conveyor 20 will be stopped before the article reaches the print heads 22, and an alarm event may be generated to alert the operator.

Accordingly, an Inline Printer for Printing Discrete Three-Dimensional Articles Of Varying Size has been disclosed. Although various example printing apparatus has been described and shown in the context of certain example embodiments (i.e. printing apparatus 2, 2a, 2b, 2c, 2d and 2e), it should be apparent that variations and alternative embodiments could be implemented in accordance with the present disclosure. For example, although the disclosed apparatus are sell suited for printing edible articles, the apparatus could also be used to print non-edible articles in a production environment wherein it is advantageous to scan and obtain measurement data for some or all of the articles being printed.

Reference in the present disclosure to an “embodiment” means that a particular feature, structure or characteristic described in connection with the embodiment may be included in at least one embodiment of the disclosed apparatus. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples may be given throughout this description. These examples are merely descriptions of specific embodiments of the invention. The scope of the invention is not limited to the examples given.

As used in this application, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” “left,” “right” and other orientational descriptors, to the extent such terms are present in the application, are intended to facilitate the description of the example embodiments of the present disclosure, and are not intended to limit the structure of the example embodiments of the present disclosure to any particular position or orientation. Terms of degree, such as “substantially” or “approximately,” to the extent such terms are present in the application, are understood by those of ordinary skill to refer to reasonable ranges outside of the given value, for example, general tolerances associated with manufacturing, assembly, and use of the described embodiments. Terms of rough approximation, such as “generally,” to the extent such terms are present in the application, are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

It is understood, therefore, that the invention is not to be in any way limited except in accordance with the text and drawings of the application, together with the spirit of the appended claims and their equivalents.

1. An apparatus for in-line, non-contact printing of images onto three-dimensional edible articles, comprising:
a conveyor operable to convey three-dimensional edible articles to be printed;
an ink supply station operable to maintain a supply of edible inks of different colors;
a height-adjustable inkjet print head module in fluid communication with the ink supply station, the print head module being operable to deposit the edible inks as full-color images onto the articles while being conveyed on the conveyor;
a computer vision station positioned upstream of the print head module and operable to scan and ascertain physical parameters of each article passing by the computer vision station on its way to the print head module for printing, the ascertained physical parameters including a height, width and length of the article, and its orientation and position on the conveyor;
a data store operable to store at least one digital image to be printed on the articles; and
a control system operable to perform image transformation of the digital image into a transformed image that is compatible with each article scanned by the computer vision station, and printing of the transformed image onto each scanned article using the physical parameters ascertained by the computer vision station, the image transformation comprising a dimensional-orientational-positional transformation of the digital image to match a size, orientation and position of each scanned article.

2. The apparatus of claim 1, wherein the computer vision station comprises a laser vision profiler operable to perform 3D measurements of moving targets.

3. The apparatus of claim 1, wherein the computer vision station comprises multiple laser proximity scanners respectively arranged to function as a start scanner, a left angle scanner, a right angle scanner, an end scanner, a height scanner, and height-to-high scanner, and further comprising an encoder, a y-size counter, a start left counter, a start right counter, an end left counter and an end right counter.

4. The apparatus of claim 1, wherein the inkjet print head module comprises a set of ink jet print heads collectively operable to print cyan, magenta, yellow and black color edible inks according to a CMYK color model, and a height adjuster operable to adjust a height of the print heads relative to the articles.

5. The apparatus of claim 1, wherein the ink supply station comprises individual ink modules for a set of cyan, magenta, yellow and black color edible inks according to a CMYK color model.

6. The apparatus of claim 1, wherein the ink supply station comprises individual ink modules for edible specialty inks or edible coatings.

7. The apparatus of claim 1, wherein the image transformation performed by the control system further comprises an image-converting screening transformation that converts the digital image from an electronic display format to a transformed image in ink jet printing format that can be printed using the print head module.

8. The apparatus of claim 1, wherein the control system is operable to implement a learn procedure to ascertain the physical parameters of a three-dimensional test article and, based on the ascertained physical parameters, perform image transformation to generate a transformed image that is stored for subsequent printing on a plurality of articles matching the test article.

9. The apparatus of claim 8, wherein the control system is operable to implement a printing procedure following the learn procedure to print the plurality of articles with the transformed image generated by the learn procedure.

10. The apparatus of claim 1, wherein the control system is operable to implement a printing procedure without implementing a prior learn procedure to print an article using a transformed image that is transformed on-the-fly during the printing procedure.

11. The apparatus of claim 1, wherein the control system comprises a scanner that is operable to process article measurement data received from the computer vision station using one or more detect filters that select and extract measurements needed to print the digital image onto a scanned article.

12. The apparatus of claim 11, wherein the one or more detect filters select and extract measurements according to a shape parameter assigned to the scanned article.

13. The apparatus of claim 12, wherein the control system comprises first and second data pathways from the scanner, the first pathway being a slow path processing pathway for a new digital image that has not yet undergone image transformation, and the second pathway being a fast path processing pathway for a digital image that has previously undergone transformation into a transformed image.

14. The apparatus of claim 13, wherein the slow path processing pathway comprises the scanner outputting article size, orientation and position data for the scanned article to a new image store for storage in association with a new digital image to be transformed into a transformed image, followed by the new image store outputting the digital image and the article size, orientation and position data to a transformation unit that transforms the digital image into a transformed image suitable for printing onto the article, followed by the transformation unit outputting the transformed image to a transformed image cache that caches the transformed image, and if a printing procedure is underway, additionally providing the transformed image to a formatter that performs print head specific formatting of the transformed image for printing.

15. The apparatus of claim 14, wherein the fast path processing pathway comprises the scanner outputting article position data to the transformed image cache, followed by the transformed image being position-adjusted in the transformed image cache, followed by the position-adjusted transformed image being provided to the formatter for print head specific formatting of the transformed image.

16. The apparatus of claim 1, further comprising an operator control panel operable to support interactive operation and monitoring of the printing apparatus by selectively displaying interfaces with inputs for image management, print head module management, ink supply management and global settings management.

17. The apparatus of claim 1, wherein the conveyor, the article profiling station, the print head module, and the control system are operable to simultaneously print plural lanes of articles.

18. The apparatus of claim 17, wherein the apparatus comprises plural conveyors, article profiling stations and print head modules, each of which is operable to simultaneously print plural lanes of articles.

19. An apparatus for in-line, non-contact printing of images onto three-dimensional edible articles, comprising:
a conveyor operable to convey three-dimensional edible articles to be printed;
an ink supply station operable to maintain a supply of edible inks of different colors;
a height-adjustable inkjet print head module in fluid communication with the ink supply station, the print head module being operable to deposit the edible inks as full-color images onto the articles while being conveyed on the conveyor;
a computer vision station positioned upstream of the print head module and operable to scan and ascertain physical parameters of each article passing by the computer vision station on its way to the print head module for printing, the ascertained physical parameters including a height, width and length of the article, and an orientation and position of the article on the conveyor;
a data store operable to store at least one digital image to be printed on the articles;
a control system operable to perform image transformation of the digital image into a transformed image that is compatible with each article scanned by the computer vision station, and printing of the transformed image onto each scanned article using the physical parameters ascertained by the computer vision station;
the image transformation performed by the control system comprising a dimensional-orientational-positional transformation of the digital image to match a size, orientation and position of each scanned article;
the image transformation performed by the control system further comprising an image-converting screening transformation that converts the digital image from an electronic display format to a transformed image in ink jet printing format that can be printed on the article using the print head module;
the control system being operable to cache the transformed image in a transformed image cache for printing on subsequent articles of the same type via fast path processing using the same transformed image;
the control system also being operable to implement a learn procedure to ascertain the physical parameters of a three-dimensional test article, and based on the ascertained physical parameters, perform image transformation to generate a transformed image that is cached in the transformed image cache for subsequent printing on a plurality of articles matching the test article;
the control system also being operable to implement a printing procedure following the learn procedure to print the plurality of articles with the transformed image that was generated by the learn procedure and cached in the transformed image cache; and
the control system also being operable to implement a printing procedure without implementing the learn procedure to print an article using a transformed image that is transformed on-the-fly during the printing procedure, with each such transformed image also being cached in the transformed image cache.

20. A method for operating the apparatus of claim 19, comprising:
implementing the learn procedure on a single edible article whose physical characteristics are representative of a set edible articles to be printed with a digital image, the learn procedure producing a transformed image that is compatible with the size of the article and its orientation and position on the conveyor; and
implementing the printing procedure on the set of edible articles to print the articles with the same transformed image that was transformed by the learn procedure and cached in the transformation cache.
